(19) United States
(12) Patent Application Publication
(10) Pub. No.: US 2013/0111373 A1
(43) Pub. Date: May 2, 2013

(54) PRESENTATION CONTENT GENERATION DEVICE, PRESENTATION CONTENT GENERATION METHOD, PRESENTATION CONTENT GENERATION PROGRAM, AND INTEGRATED CIRCUIT

(71) Applicants: Ryouichi Kawanishi, Kyoto (JP); Tomoyuki Karibe, Osaka (JP); Tomohiro Konuma, Osaka (JP)

(72) Inventors: Ryouichi Kawanishi, Kyoto (JP); Tomoyuki Karibe, Osaka (JP); Tomohiro Konuma, Osaka (JP)

(21) Appl. No.: 13/702,143

(22) PCT Filed: Nov. 21, 2011
(86) PCT No.: PCT/JP2011/006456

§ 371 Date: Dec. 5, 2012

(30) Foreign Application Priority Data
May 7, 2011 (JP) 2011-148910

(51) Int. Cl. G06F 3/0484

(52) U.S. Cl. CPC G06F 3/0484
USPC 715/762

(57) ABSTRACT

To provide a presentation content generation device that generates various types of presentation contents by dynamically generating a template appropriate for the substance of each content set. The presentation content generation device includes an attribute information extraction unit 2 that extracts attribute information indicating image feature from a content set stored in a local data storage unit 1, a design type determination unit 4 that determines a base land pattern and a color of a template based on the extracted attribute information, a selection index type determination unit 5 that, based on the extracted attribute information, selects one or more contents to be placed on the template and respective placement positions of the selected contents on the template, and a view format conversion unit 6 that places the selected contents on the respective placement positions to generate a presentation content.

### TECHNICAL FIELD

The present invention relates to an art of generating a presentation content by converting contents owned by a user into a format easily viewable for the user such as a digital album.

### BACKGROUND ART

Recently, there has been developed a viewing support art for effectively presenting a user with a large amount of digital contents (hereinafter, just “contents”) that are recorded and held by the user. As an example of such a viewing support art, Patent Literature 1 discloses an art for generating a digital album based on a type of digital album designated by the user, such as a digital album for travel, a digital album for wedding ceremony, and a digital album for growth record. Specifically, a large amount of images are classified into groups based on the type of digital album, and any of the images that conforms conditions described in a template that has been associated beforehand with the type of digital album is selected and placed. As a result, in the case where the user designates a digital album for travel for example, images relating to travel are selected among the large amount of images, and the selected images are placed in a template for travel. This results in completion of a digital album for travel.

### CITATION LIST

### Patent Literature

[Patent Literature 1] Japanese Patent Application Publication No. 2007-143093

### SUMMARY OF INVENTION

### Technical Problem

However, according to the above art, since templates corresponding to the types of digital album are determined beforehand, generation of the same type of digital albums cause the user to feel that similar digital albums are generated every time with no special change.

In view of the above problem, the present invention aims to provide a presentation content generation device capable of generating various types of presentation contents by dynamically generating a template appropriate for the substance of a content set.

### Solution to Problem

In order to solve the above problem, one aspect of the present invention provides a presentation content generation device, comprising: an extraction unit configured to extract respective attributes of a plurality of contents that constitute a content set, the attributes indicating respective image features of the plurality of contents; a design determination unit configured to determine a design of each of one or more templates based on the attributes, the design indicating a base pattern and a color of the template; a selection placement unit configured to, based on the attributes, select one or more contents to be placed on each of the templates, and determine respective placement positions of the selected contents on each of the templates; and a generation unit configured to place the selected contents on the respective determined placement positions on each of the templates to generate a presentation content.

### Advantageous Effects of Invention

With the above structure, the presentation content generation device relating to the present invention dynamically generates one or more templates appropriate an attribute of a content set, and applies the generated templates to generate various types of presentation contents. As a result, unlike a conventional art of uniquely determining a template for an event theme, the presentation content generation device relating to the present invention generates a template appropriate for the visual appearance and the substance of a content. This enables the user to enjoy contents owned by the user in various types of view formats.

### BRIEF DESCRIPTION OF DRAWINGS

FIG. 1 shows an example of a template relating to Embodiment 1 of the present invention.

FIG. 2 is a block diagram showing a presentation content generation device relating to Embodiment 1 of the present invention.

FIG. 3 shows an example of device metadata information relating to Embodiment 1 of the present invention.

FIG. 4 shows an example of usage metadata information relating to Embodiment 1 of the present invention.

FIG. 5 shows an example of analysis metadata information relating to Embodiment 1 of the present invention.

FIG. 6 is a block diagram showing the structure of a design type determination unit relating to Embodiment 1 of the present invention.

FIG. 7 shows an example of base design information and decoration part design information relating to Embodiment 1 of the present invention.

FIG. 8 is a flowchart showing base determination processing relating to Embodiment 1 of the present invention.

FIG. 9 is a flowchart showing decoration part determination processing relating to Embodiment 1 of the present invention.

FIG. 10 is a block diagram showing the structure of a selection index type determination unit relating to Embodiment 1 of the present invention.

FIG. 11 shows an example of a layout frame and a query relating to Embodiment 1 of the present invention.

FIG. 12 is a flowchart showing selection index type determination processing relating to Embodiment 1 of the present invention.

FIG. 13 is a flowchart showing selection index type determination processing for event theme “Party” relating to Embodiment 1 of the present invention.

FIG. 14 is a flowchart showing selection index type determination processing for event theme “Travel” relating to Embodiment 1 of the present invention.

FIG. 15 is a flowchart showing presentation content generation processing relating to Embodiment 1 of the present invention.

FIG. 16 shows an example of a presentation content relating to Embodiment 1 of the present invention.

FIG. 17 shows an example of the type of attribute information and criteria for reliability thereof relating to Embodiment 2 of the present invention.

FIG. 18 shows an example of an event determination granularity, an event, and conditions on event determination relating to Embodiment 2 of the present invention.

FIG. 19 shows an example of the relation between combination of the types of attribute information and a template to be selected with respect an event relating to Embodiment 2 of the present invention.

FIG. 20 is a flowchart of presentation content generation processing relating to Embodiment 2 of the present invention.

FIG. 21 is a block diagram showing a presentation content generation device relating to Embodiment 3 of the present invention.

FIG. 22 is a flowchart showing hierarchy processing relating to Embodiment 3 of the present invention.

FIG. 23 shows templates (base patterns) one-to-one corresponding to groups in hierarchies relating to Embodiment 3 of the present invention.

FIG. 24A to FIG. 24C each show an example of a template to be applied to a content set having a hierarchical structure relating to Embodiment 3 of the present invention.

FIG. 25 is a flowchart of presentation content generation processing on a content set based on hierarchical information relating to Embodiment 3 of the present invention.

FIG. 26 is a block diagram showing a presentation content generation device relating to Embodiment 4 of the present invention.

FIG. 27 shows an example of base design information and decoration part design information relating to Embodiment 4 of the present invention.

FIG. 28 shows an example of layout frame information and query information relating to Embodiment 4 of the present invention.

FIG. 29 is a block diagram showing a presentation content generation device relating to Embodiment 5 of the present invention.

FIG. 30 is a flowchart showing an example of recursive template determination processing relating to Embodiment 5 of the present invention.

FIG. 31 shows the structure of a system in the case where a cloud has a template generation function relating to a modification example of the present invention.

FIG. 32 shows the structure of a presentation content generation device relating to a modification example of the present invention.

### DESCRIPTION OF EMBODIMENTS

The following describes embodiments of the present invention with reference to the drawings.

### 1. Embodiment 1

Embodiment 1 of the present invention is described below with reference to the drawings.

A presentation content generation device relating to Embodiment 1 converts a content set composed of a plurality of contents owned by a user into a user's desired view format to generate a presentation content. The contents are each an image, a video, a text, a music file, or the like. More specifically, the contents are each an image in JPEG (Joint Photographic Experts Group) or the like, or a video in MPEG (Moving Picture Experts Group) or the like, for example. The desired view format is specifically a format of digital album, slide-show, HTML (HyperText Markup Language), or the like.

In the present embodiment, a presentation content is composed of one or more slides. The slides are displayed on a display in order. Alternatively, in accordance with a user instruction to designate any of the slides, the designated slide is displayed on the display. The slides are each composed of one or more contents placed on a template that is a form on which one or more contents are to be placed.

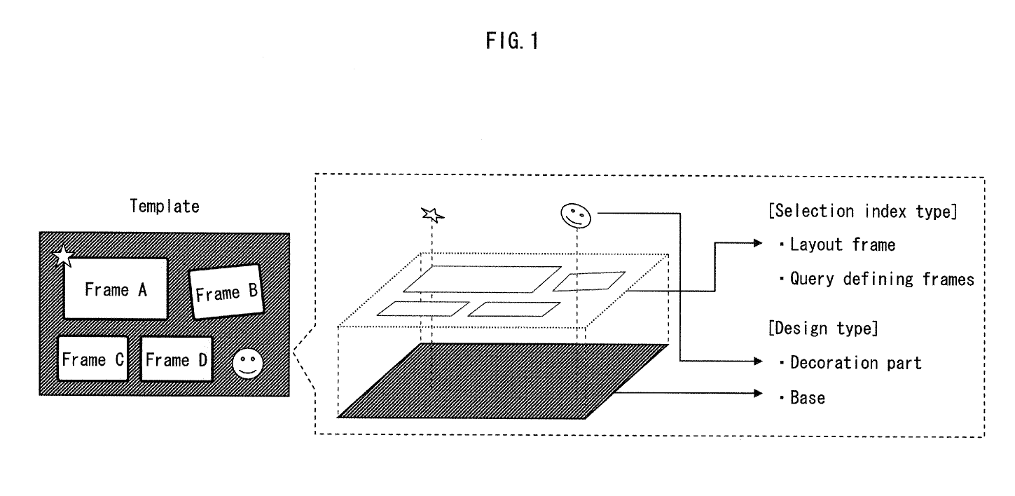

Here, the general outline of template is described with reference to FIG. 1.

FIG. 1 shows an example of a template relating to the present embodiment.

The template is determined based on the design type defining a visual appearance thereof and a selection index type defining a substance thereof. In the present embodiment, the design indicates a color and a base pattern of the template, and does not indicate the shape of a content to be placed on the template such as a rectangle, a circle, and a star. The design of the template is determined based on the design type, and the shape of the template is determined based on the selection index type, separately.

The design type includes a decoration part and a base. The base indicates the background on the template. The decoration part is a part for decoration to be placed on the base.

The selection index type includes a layout frame and a query. The layout frame is a virtual framework for placing one or more contents. Inside each of virtual frames (frames A to D shown in FIG. 1, for example) provided in a layout frame, one or more contents are placed. The query defines a selection criterion for selecting a content among a content set that is to be placed on each of the frames.

As described above, a slide is composed of a decoration part placed on a base which is the background, and a content which is placed inside each frame whose placement position is defined by the layout frame. A presentation content is composed of a set of one or more slides. Templates may be generated so as to differ for each slide or for each two or more slides. Also, templates each may be associated with other templates so as to change in time series. Furthermore, a single template may be generated so as to be common in all contents included in a content set. Moreover, it may be possible to employ the structure in which the contents included in the content set are classified into a plurality of groups such as event units relating to the content set, and a template may be generated for each group.

Unlike a conventional art for uniformly selecting a template corresponding to an event attached to a content set, the presentation content generation device relating to the present embodiment generates and uses various templates based on respective pieces of attribute information of contents included in a content set. This enables display of the contents in various view modes so as not to keep a user from being bored, thereby improving the user's satisfaction. Here, attribute information is information indicates an attribute of a content. In the present embodiment, the attribute information includes device metadata information, usage metadata information, and analysis metadata information. The device metadata information is for example information given by a device such as EXIF (Exchangeable Image File Format) information. The usage metadata information is for example information given as an event name by the user such as athletic meet. The analysis metadata information is for example information extracted as a result of image analysis. These types of attribute information are detailed later.

### 1.1. Structure

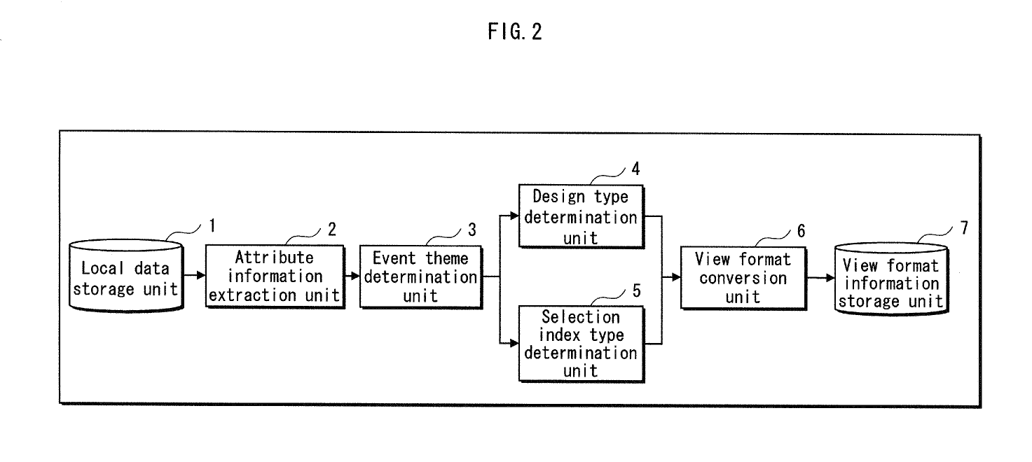

FIG. 2 is a block diagram showing the structure of a presentation content generation device relating to the present embodiment.

The presentation content generation device includes, as shown in FIG. 2, a local data storage unit 1, an attribute information extraction unit 2, an event theme determination unit 3, a design type determination unit 4, a selection index type determination unit 5, a view format conversion unit 6, and a view format information storage unit 7.

The local data storage unit 1 is a storage medium, and stores therein a content set composed of a plurality of contents. The storage medium is a large capacity media disc such as an HDD (Hard Disk Drive) and a DVD, a storage device such as a semiconductor memory, or the like. The contents are, for example, each file data owned by a user limited to a certain extent, such as a photograph image and video data photographed by a family member of the user.

The contents each have attached thereto attribute information indicating various types of attributes of the content. The attribute information includes, for example, device metadata information, usage metadata information, and analysis metadata information.

Device metadata information is attached to a content by a device that has generated the content. The device metadata information is, for example, EXIF information, extended metadata for video, music metadata, any combination of these pieces of information, or the like. The device metadata information specifically includes photograph time information, GPS (Global Positioning System) information that is photograph location information, photograph mode information indicating a photograph method, information such as a parameter of a camera at photographing, information of a sensor for use in photographing, feature information of music, and so on.

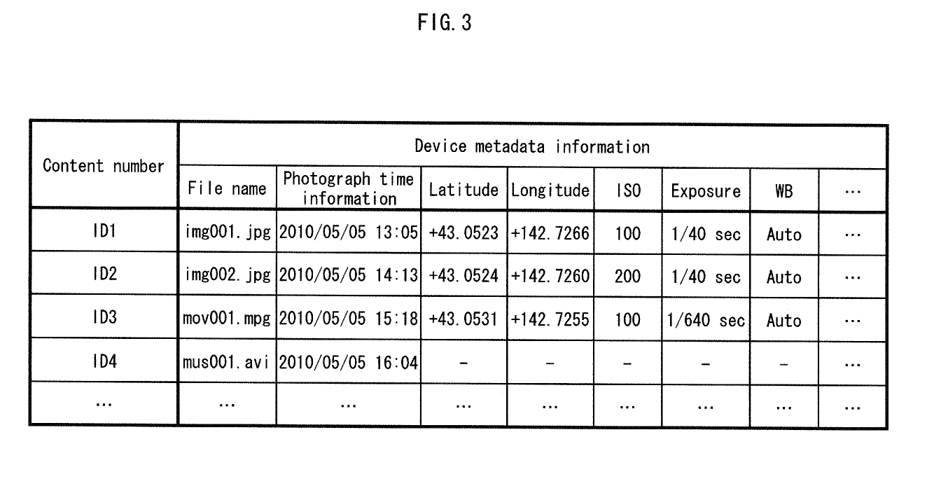

FIG. 3 shows an example of device metadata information relating to the present embodiment.

With respect to each content, device metadata information includes an ID number (content number) attached to the content, a file name of the content, photograph time information indicating a time when the content has been photographed, latitude-longitude information that is obtained based on GPS information as geographical location information at the photograph time, ISO (International Organization for Standardization) sensitivity information for adjusting the brightness during photographing, exposure information for adjusting the brightness for appropriate viewing, WB (White Balance) information for adjusting a color balance during photographing, and so on.

Usage metadata information is based on the user's input. For example, the usage metadata information is attached to a content via user's input, or attached by a device based on the usage history of the device by the user. The usage metadata information includes, for example, information directly input by the user indicating an event name, a personal name, a photographer name, and so on, and usage history information indicating the viewing frequency of a content, and so on.

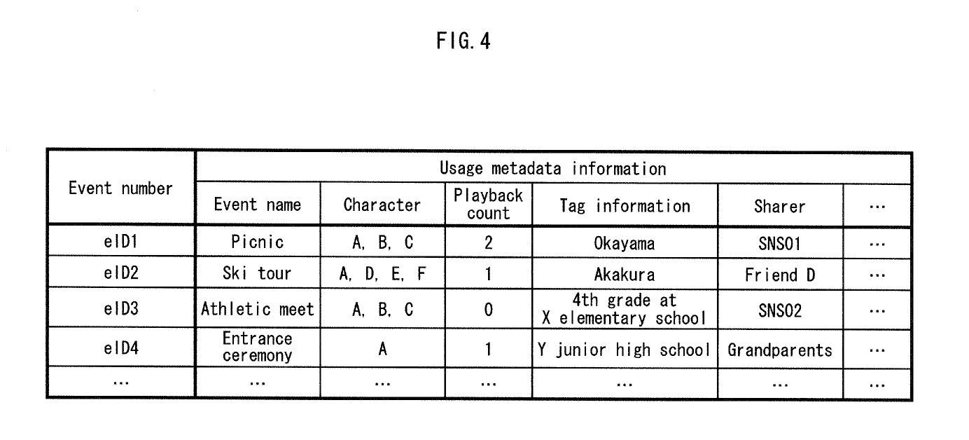

FIG. 4 shows an example of usage metadata information relating to the present embodiment.

With respect to each content, usage metadata information includes an event number, an event name, a character name, a playback count, tag information, a sharer, and so on. The event number is a number for identifying an event. The event typically indicates a festival, an entertainment, a commemoration, and the like relating to the user, such as a picnic, a ski tour, an athletic meet, and an entrance ceremony. Each content corresponds to at least one event. The character name indicates a name of a person appearing in the event. The playback count indicates the counts that the content corresponding to the event has been played back by a playback device or the like. The tag information is information arbitrarily attached by the user, such as a name of a photograph location. The sharer is information indicating a party with which the content corresponding to the event is to be shared via a service on a network or the like. Also, in addition to these types of information, the usage metadata information may include, for example, information indicating the details of a service with use of the content, such as photographic development of the content and DVD packaging of the content.

With respect to each content, analysis metadata information indicates a feature of all or part of the content. The analysis metadata information is extracted as a result of analysis on the content.

With respect to each image as a content, analysis metadata information includes, for example, an image feature value, image color information, texture information, a high-level feature value, face information, other information, and so on.

The image feature value is a high-level feature value representing a feature of a subject resulting from calculation based on a low-level feature value such as color information and texture information that are basic feature value information of the image.

The image color information is information indicating RGB color values calculated as a statistical value of the image, the RGB color values calculated as color phase information indicating the RGB color values converted into an HSV color space or a YUV color space, or the RGB color values calculated as statistical value information such as color histogram and color moment.

The texture information is information indicating an edge feature of the image that has been line-segment detected and calculated as a statistical value of the image for each certain angle.

The high-level feature value is a feature value indicating a feature of a local region focusing on a feature point, indicating the shape of an object, and so on. The high-level feature value is, for example, a feature value calculated by SIFT (Scale-Invariant Feature Transform), SURF (Speeded Up Robust Features), and HOG (Histograms of Oriented Gradients).

The face information is information indicating whether any face appears in the image, the number of faces appearing in the image, and so on that are calculated with use of a face detection technique from a unique feature value that enables a subject included in the image to be recognized such as a person, the person's face, and an object.

Other information is, for example, analysis information, with use of an image recognition technique, that relates to the size of the person's face, the color and shape of the person's clothes, whether any person, car, or pet animal such as a dog and cat appears in the image. Also, other information is, for example, analysis information that relates to movement in time series of a video and scenes of the video. Furthermore, other information is, for example, analysis information that relates to all or part of sights, composition, melody of music, and so on of a content set.

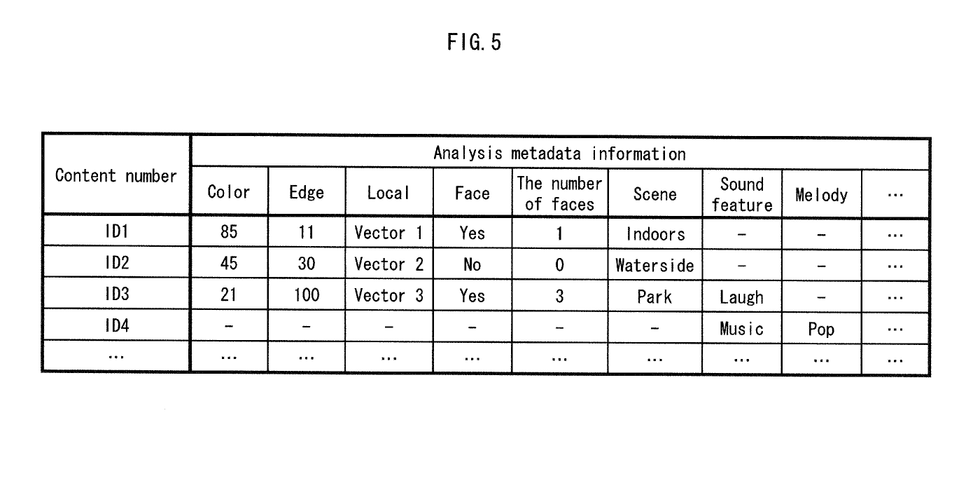

FIG. 5 shows an example of analysis metadata information relating to the present embodiment. With respect to each content, analysis metadata information includes, as shown in FIG. 5, a content number, a color, an edge, a local (vector information), a person's face, the number of person's faces, a scene, a sound feature, and a melody.

The analysis metadata information may be generated by the presentation content generation device, specifically by an attribute information extraction unit 2 included therein which is described later. Alternatively, the analysis metadata information may be extracted by other device. In the former case, when a content is stored into the local data storage unit 1, metadata information is generated by the presentation content generation device on a timely basis as necessary.

The attribute information extraction unit 2 acquires a content set and attribute information stored in the local data storage unit 1, and outputs the acquired content set and attribute information. Also, as described above, on a timely basis as necessary, the attribute information extraction unit 2 analyzes the content set to generate analysis metadata information, and stores the generated analysis metadata information in the local data storage unit 1.

The event theme determination unit 3 determines an event theme based on the attribute information acquired by the attribute information extraction unit 2. Here, the event theme corresponds to the event described above, and is extracted from the content set. The event theme is common among contents included in the content set. In the case where a content set includes images photographed at an event of a party for example, the event theme determination unit 3 determines an event theme of the content set as “Party”. The event theme is, for example, party, travel, wedding ceremony, athletic meet, picnic, entrance ceremony, and so on.

Note that one event theme is determined for each content set. In the case where a content set includes a plurality of content groups each relating to a different type of event such as a group of contents relating to party and a group of content relating to travel, an event theme is determined for each group. Such a content group relating to the same type of event is referred to as “sub content set”. Hereinafter, a content set and a sub content set that are each a target of template generation are collectively referred to as “target content set”.

The event theme determination unit 3 for example determines an event theme based on usage metadata information, device metadata information, and analysis metadata information in this order, which are included in attribute information. The following describes a method of determining an event theme.

(1) An event name indicated by the usage metadata information is determined as the event theme without modification.

(2) In the case where the event theme is not determined based on the usage metadata information, latitude-longitude information, and photograph time information, which are included in the device metadata information, are each calculated as a statistical value for units of contents, and the event theme is determined based on a result of the calculation. For example, in the case where the photograph time information indicates “spring” and the latitude-longitude information indicate a location of “Expo '70 Commemorative Park”, the event theme is determined as “Expo '70 Commemorative Park in spring”. In such a case, the event theme determination unit 3 stores therein beforehand, as database, the correspondence between latitudes and longitudes indicated by the latitude-longitude information and landmark names such as “Expo '70 Commemorative Park”. Furthermore, event theme determination unit 3 stores therein beforehand the correspondence between combinations of photograph time information and latitude-longitude information and event themes.

(3) In the case where the event theme is not determined based on the device metadata information, a scene is calculated as a statistical value for units of content sets based on the analysis metadata information, and the calculated scene is determined as the event theme without modification. For example, in the case where information indicating a scene “indoors” is acquired from the analysis metadata information, the event theme is determined as “Indoors”. Similarly, in the case where information indicating a scene “waterfront” is acquired from the analysis metadata information, the event theme is determined as “Waterfront”. Also, in the case where information indicating a scene “indoors” and information indicating a scene “five main persons (five persons' faces)” are acquired from the analysis metadata information, the event theme is determined as “House party”. Note that the correspondence between pieces of information indicating these respective scenes and event themes is stored beforehand.

Note that the event theme determination methods (1) to (3) are just examples.

Alternatively, any one of usage metadata information, device metadata information, and analysis metadata information may be used or any combination of these pieces of information may be used as long as an event theme can be determined.

The following describes a specific example of combination of the pieces of information. In the case where usage metadata information includes character names indicating only family members and device metadata information includes latitude-longitude information indicating a location “park” and analysis metadata information includes a scene “picnic”, an event theme is determined as “Family picnic in park” as a result of combination of these pieces of information.

Here, in order to determine an event theme, the event theme determination unit 3 stores therein an event theme determination table indicating the correspondence between event themes and each of metadata information, analysis metadata information, usage metadata information, and any combination of these pieces of information.

The design type determination unit 4 determines a design type based on respective pieces of attribute information of contents included in a target content set.

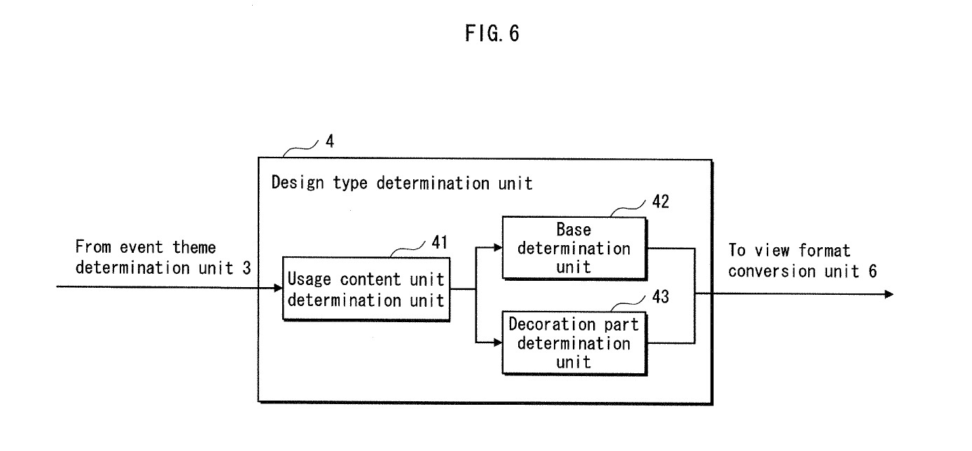

FIG. 6 is a block diagram showing the structure of the design type determination unit 4.

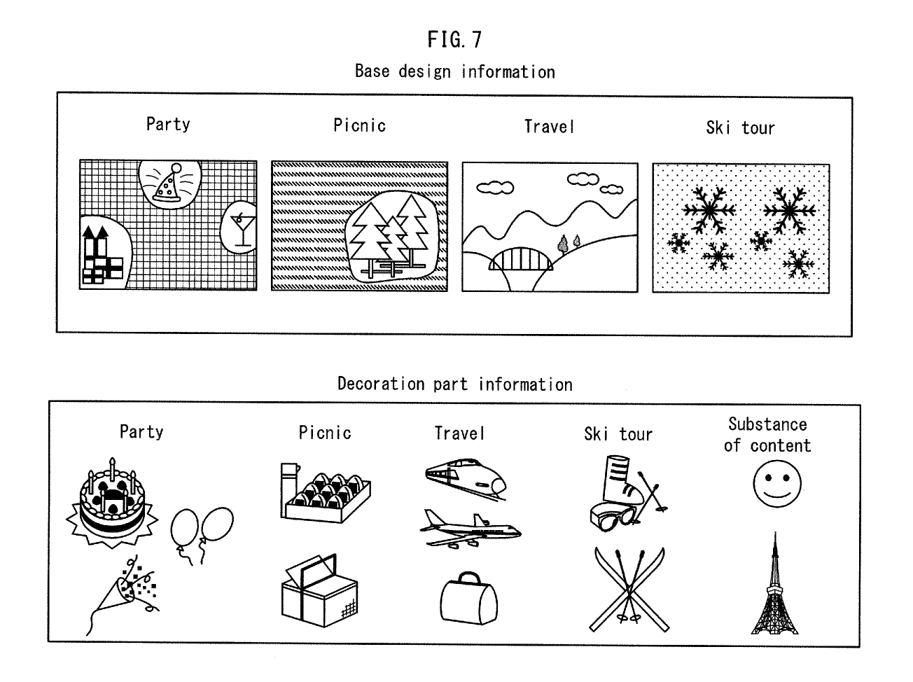

FIG. 7 shows an example of base design information and decoration part design information indicating a base and a decoration, respectively which are determined by the design type determination unit 4.

The design type determination unit 4 includes, as shown in FIG. 6, a usage content unit determination unit 41, a base determination unit 42, and a decoration part determination unit 43.

The usage content unit determination unit 41 determines a content unit that is a unit for use in template generation based on attribute information. This content unit may be an entire target content set, a sub content of the target content set, or part of the sub content set such as a slide. Also, the content unit may be designated via the user's input. Furthermore, in the case where a plurality of types of content units are permitted to be determined, any one of the plurality of types of content units may be used or the plurality of types of content units may be used in combination.

In the present embodiment, the usage content unit determination unit 41 determines the content unit as a sub content set, for example.

With respect to the content unit determined by the usage content unit determination unit 41, the base determination unit 42 determines a base such as described above, which represents the basic visual appearance of a template such as a color and a pattern, and stores therein base design information indicating the determined base.

The base determination unit 42 stores therein a base for each event theme beforehand.

FIG. 7 schematically shows respective bases corresponding to event themes of party, picnic, travel, and ski tour.

On the base of the event theme “Party”, patterns representing party hat, gift, and cocktail (patterns for party) are arranged as a base pattern, for example. On the base of the event theme “Picnic”, a pattern representing trees (patterns for picnic) is arranged, for example. On the base of the event theme “Travel”, a pattern representing landscape (patterns for travel) is arranged, for example. On the base of the event theme “Ski tour”, a pattern schematically representing snowflakes (patterns for ski tour) is arranged, for example. In addition to the patterns shown in FIG. 7, the base determination unit 42 stores therein beforehand, as a base pattern, a base for each event theme. For example, on a base of an event theme “Picnic in park”, patterns representing playground equipment, grasses, and goods for picnic are arranged, for example.

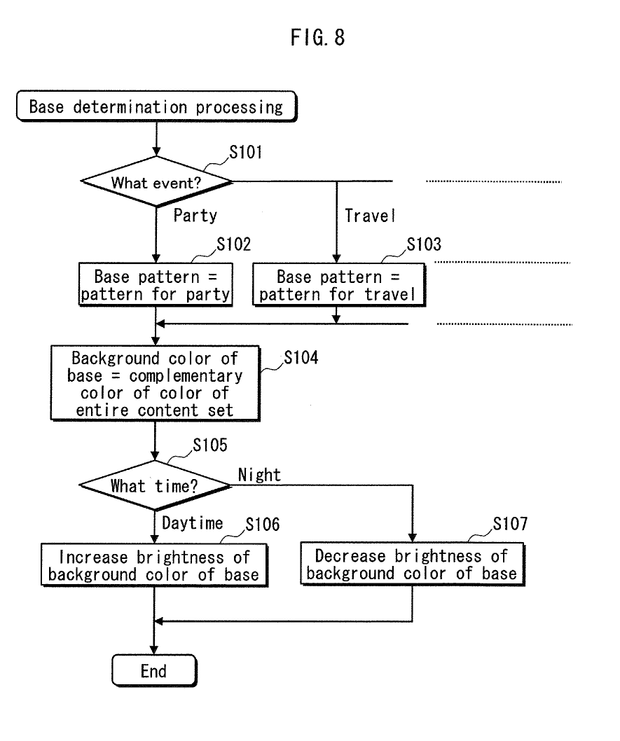

FIG. 8 is a flowchart showing base determination processing.

In the case where an event theme of a target content set is “Party” (S101: Party), the base determination unit 42 selects a pattern for party as a base pattern (S102). In the case where the event theme is “Travel” (S101: Travel), the base determination unit 42 selects a pattern for travel as a base pattern (S103). With respect to each of other event themes, the base determination unit 42 selects a pattern for the event theme in the same way. Then, the base determination unit 42 selects, as a background color of a base, a complementary color of a color of the entire target content set (S104). The complementary color is used because when being arranged on a template, the target content is viewed as being accentuated. Then, in the case where photograph time information of attribute information indicates daytime (S105: Daytime), the base determination unit 42 performs processing for increasing the brightness of the background color of the base by a predetermined value (S106). In the case where the photograph time information indicates night (S105: Night), the base determination unit 42 performs processing for decreasing the brightness of the background color of the base by the predetermined value (S107). As a result, an approximate time when each content has been photographed is reflected in a template on which the content is to be placed. This leads to diversification in template. Through the above processing, the base is determined.

Note that the base determination method employed by the base determination unit 42 is not limited to the above examples. Any determination method may be employed as long as the basic visual appearance of a template as a base is dynamically determined based on attribute information.

With respect to the content unit determined by the usage content unit determination unit 41, the decoration part determination unit 43 determines a decoration part, and stores therein decoration part design information indicating the determined decoration part.

FIG. 7 schematically shows an example of respective decoration parts for use in event themes of party, picnic, travel, and ski tour.

Decoration parts for use in the event theme “Party” are small images for decoration representing cake, balloon, and small items such as cracker and party whistle, for example. Also, decoration parts for use in the event theme “Picnic” are small images for decoration representing two types of lunch baskets, for example. Decoration parts for use in the event theme “Travel” are small images for decoration representing Shinkansen bullet train, airplane, and travelling bag, for example. Decoration parts for use in the event theme “Ski tour” are small images for decoration representing two types of ski equipment, for example. Furthermore, various types of decoration parts are used irrespective of the types of event theme, as shown below. In the case where a subject with smile is included in a content, a decoration part representing smiley face mark is selected. In the case where Tokyo Tower is included in a content as a subject, a decoration part representing Tokyo Tower is selected. In the case where snow is included in a content, a decoration part representing snowflake mark is selected. In the case where a content is photographed in the morning, a decoration part representing morning sun is selected. Moreover, in the case where the decoration part determination unit 43 stores therein decoration parts representing two or more types of the same item, such as the two types of lunch baskets described above, the decoration part determination unit 43 may select any of these decoration parts at random. Alternatively, the decoration part determination unit 43 may select any of these decoration parts that is similar in color or shape to a subject (lunch basket in this example) included in a content.

In the present embodiment, an object corresponding to each decoration part is included in a content, the decoration part determination unit 42 selects the decoration part so as to be placed on a template.

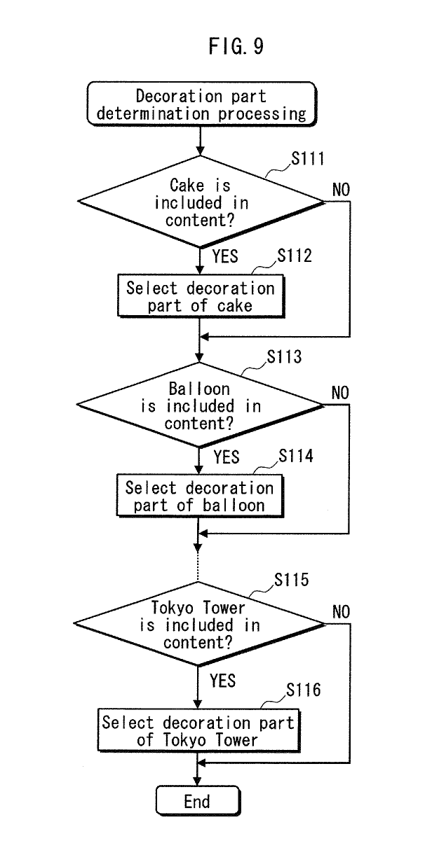

FIG. 9 is a flowchart showing decoration part determination processing.

The decoration part determination unit 42 judges whether a cake is included in a content (S111). If judging that the cake is included in the content (S111: YES), the decoration part determination unit 42 selects a decoration part representing cake (S112). If judging that no cake is included in the content (S111: NO), the decoration part determination unit 42 does not select the decoration part representing cake.

Next, the decoration part determination unit 42 judges whether a balloon is included in the content (S113). If judging that the balloon is included in the content (S113: YES), the decoration part determination unit 42 selects a decoration part representing balloon (S114).

Next, the decoration part determination unit 42 judges whether Tokyo Tower is included in the content (S115). If judging that Tokyo Tower is included in the content (S115: YES), the decoration part determination unit 42 selects a decoration part representing Tokyo Tower (S116).

Also, in the same manner as the respective decoration parts representing cake, balloon, and Tokyo Tower, in the case where other subject is included in the content, the decoration part determination unit 42 selects a decoration part representing the other subject.

Note that the number of decoration parts to be placed on each slide may be determined beforehand. In this case, when the determined number of decoration parts are selected, decoration part selection processing completes. Also the decoration part determination unit 42 starts with the judgment on cake for selecting a decoration part. Alternatively, the order of judgment on the objects for selecting decoration parts may be randomly changed. Also, in the case where the correlation between event themes and possibilities of decoration parts to be selected is recognized beforehand, specifically in the case where empirical recognition indicates that a decoration part representing cake has a high possibility to be selected for the event theme “Party”, the decoration part determination unit 42 may start with judgment on a object for a decoration part that has a high possibility to be selected. Also, the decoration part determination unit 42 may associate beforehand a decoration part to be selected with each event theme, pieces of attribute information, or a combination of the event theme and the pieces of attribute information, and select an associated decoration part for each event theme irrespective of the substance of a content. In the case where the event theme is “Party” for example, the decoration part determination unit 42 may unconditionally select a decoration part representing cake, candle, or the like. Also, in the case where photograph time information among the attribute information indicates a time around lunchtime, the decoration part determination unit 42 may unconditionally select a decoration part representing food. Also in the case where the event theme is “Picnic” and the photograph time information among the attribute information indicates the time around lunchtime, the decoration part determination unit 42 may select a decoration part representing boxed lunch such as sandwiches.

By selecting a decoration part such as described above, it is possible to select various types of decoration parts in detail in accordance with the substance of a target content set, compared with determination in units of event themes.

Note that the decoration part determination method employed by the decoration part determination unit 43 is not limited to the above described methods. Alternatively, any decoration part determination method may be employed as long as a part for decoration to be placed on a base as a decoration part is determined based on attribute information.

The selection index type determination unit 5 determines a selection index type defining the substance of a template based on attribute information such as described above.

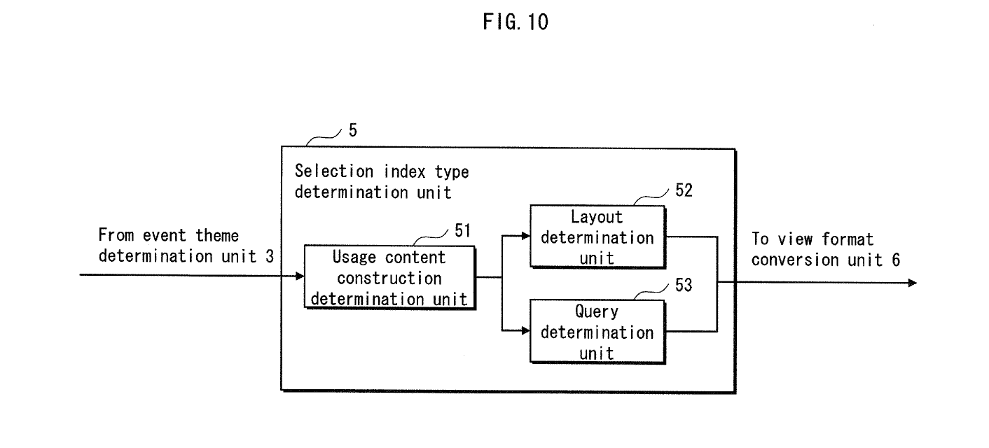

FIG. 10 is a block diagram showing the structure of the selection index type determination unit 5.

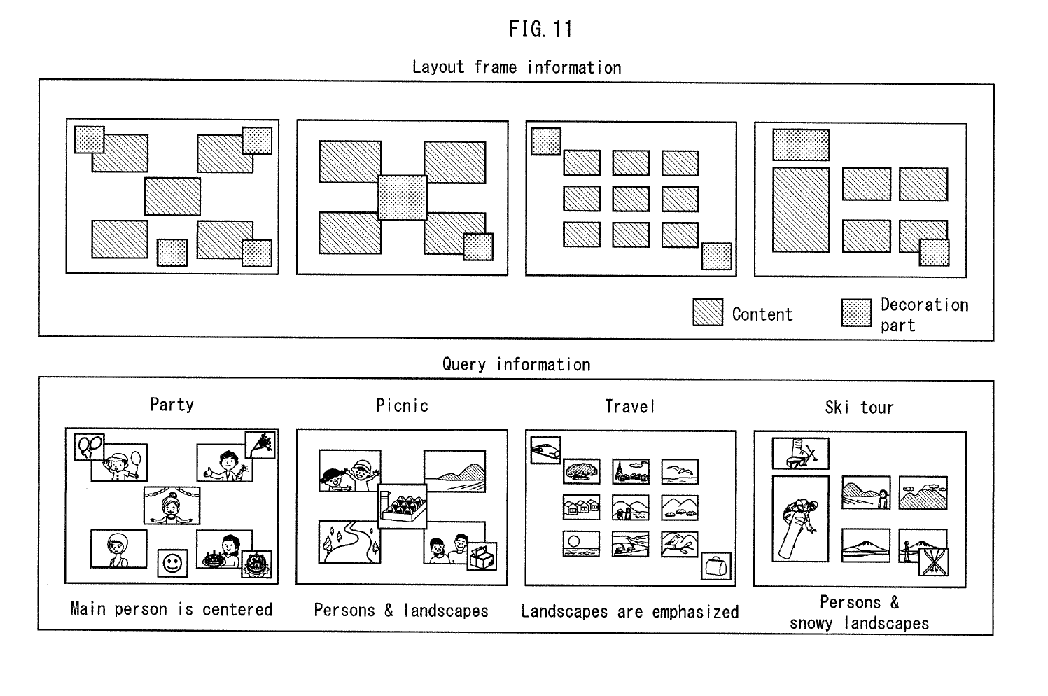

FIG. 11 shows a conceptual example of a layout frame indicated by layout frame information and a query indicated by query information.

The selection index type determination unit 5 includes, as shown in FIG. 10, a usage content construction determination unit 51, a layout determination unit 52 for determining a layout frame such as described above, and a query determination unit 53 for determining a query such as described above.

The usage content construction determination unit 51 determines a content construction that is a unit for determining the selection index type, based on the attribute information. The usage content construction determination unit 51 determines a content construction based on a photographing method, the substance of photographing, and so on. This content construction may be an entire target content set, a sub content set of the target content set, or part of the sub content set such as a slide. Also, the content construction may be designated via the user's input. Furthermore, in the case where the usage content construction determination unit 51a is capable of determining a plurality of types of content constructions, any one of the plurality of types of content constructions may be used or the plurality of types of content constructions may be used in combination. In the present embodiment, the usage content construction determination unit 51 determines the content construction as a sub content set, for example.

Alternatively, as the content construction, the unit (construction) that is equivalent to the content unit, which is determined by the usage content unit determination unit 41 as described above, may be used. In this case, the usage content construction determination unit 51 may be integrated to the usage content unit determination unit 41.

The layout determination unit 52 determines a layout frame such as described above based on the content construction determined by the usage content construction determination unit 51.

The query determination unit 53 determines a query with respect to the content construction determined by the usage content construction determination unit 51.

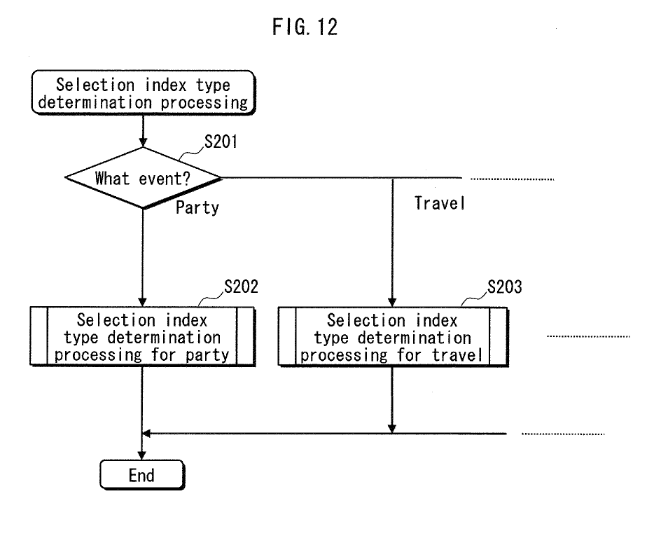

FIG. 12 is a flowchart showing selection index type determination processing.

In the present embodiment, a selection index type is determined for each event theme of a target content set based on attribute information.

Firstly, the usage content unit determination unit 41 determines the content construction, and switches between the types of selection index type determination processing different for each event theme, depending on an event theme relating to the determined content construction (Steps S201, S202, S203, . . . ).

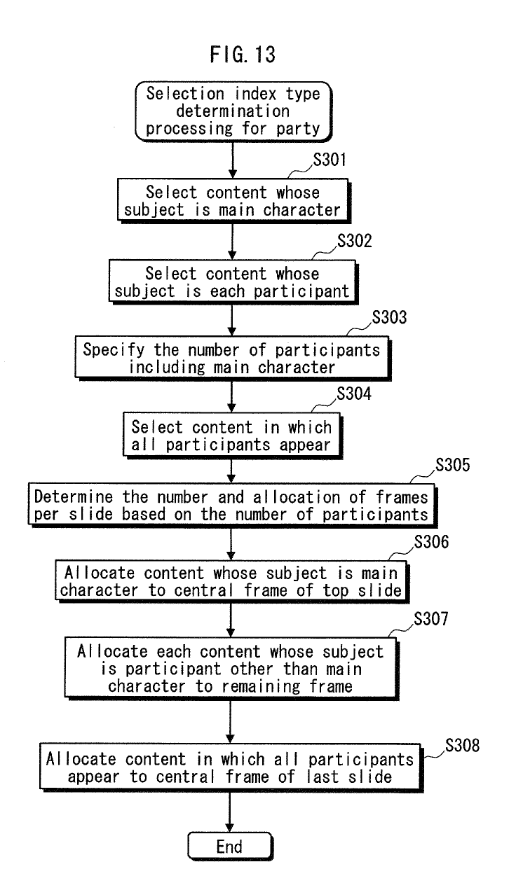

FIG. 13 is a flowchart showing selection index type determination processing for event theme “Party” in the case where the event theme is determined as “Party” (S201: Party) shown in FIG. 12.

Firstly, the layout determination unit 52 selects a content whose subject is a main character of a party from a target content set (S301). Next, the layout determination unit 52 selects each of contents included in the target content set whose subject is a participant in the party other than the main character (S302). Then, the layout determination unit 52 specifies the number of participants in the party including the main character (S303), and judges whether the target content set includes a content in which all the participants appear (S304).

Then, the layout determination unit 52 determines the number of frames and placement of each frame per slide, based on the number of the participants and whether the target content set includes the content in which all the participants appear (S305). In the present embodiment, the number of frames per slide is determined as a maximum of five, for example. Also, the frames are determined so as to be arranged on the center and the four corners on the slide. The layout determination unit 52 determines the number of frames and placement of each frame per slide and the number of slides, so as to reserve the same number of frames as the participants and a frame on which a content in which all the participants appear if the target content set includes such a content. The top slide has the central frame larger than other frames included therein, such that the content whose subject is the main character is allocated to the central frame. Also, the last slide has the central frame larger than other frames included therein, such that the content in which all the participants appear is allocated to the central frame. Note that other slides have the central frame and respective frames on the four corners that are no difference in size.

Next, the query determination unit 53 determines a query, such that the content whose subject is the main character is allocated to the central frame on the top slide (S306), each content whose subject is a participant other than the main character is allocated to a different one of the frames (S307), and the content in which all the participants appear is allocated to the central frame on the last slide (S308).

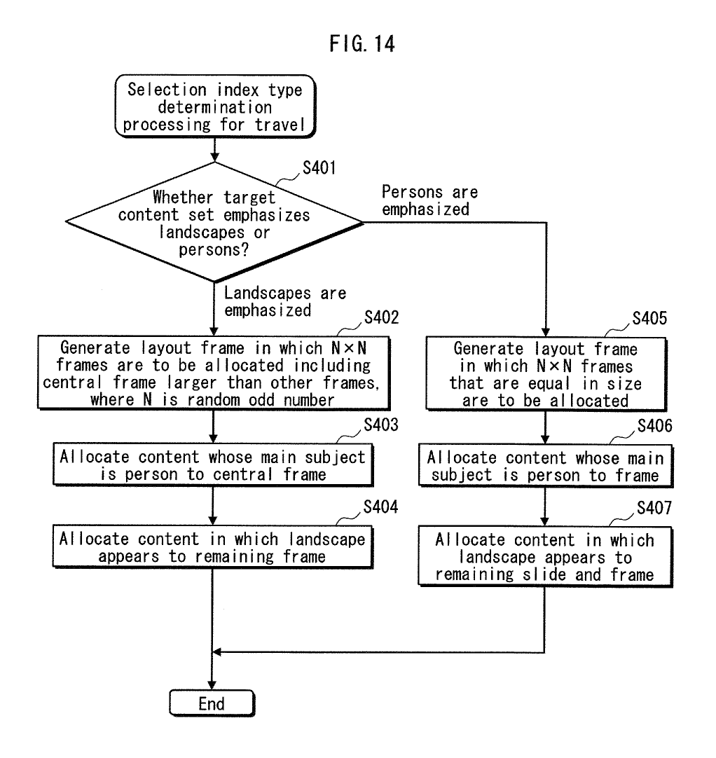

FIG. 14 is a flowchart showing selection index type determination processing for event theme “Travel” in the case where the event theme is determined as “Travel” (S201: Travel) shown in FIG. 12.

Firstly, the layout determination unit 52 judges whether a target content set places emphasis on landscapes or persons (S401). Here, in the case where a certain rate or more of contents included in the target content set each include one or more persons, the layout determination unit 52 judges that the target content set places emphasis on persons. On the contrary, in the case where less than the certain rate of contents included in the target content set each include one or more persons, the layout determination unit 52 judges that the target content set places emphasis on landscapes.

If judging that the target content set places emphasis on landscapes (S401: Landscapes are emphasized), the layout determination unit 52 generates a layout frame in which N×N frames are to be provided including the central frame larger than other frames, where N is a random odd number (S402). The query determination unit 53 determines a query such that a content whose main subject is a person is allocated to the central frame (S403) and each content in which landscape appears is allocated to a different one of other remaining frames (S404).

On the contrary, if judging that the target content set places emphasis on persons (S401: Persons are emphasized), the layout determination unit 52 generates a layout frame in which N×N frames that are equal in size are to be provided (S405). The layout determination unit 52 allocates each of contents whose main subject is a person to a different one of the frames (S406). In the case where it is impossible to allocate contents to frames provided on a single slide, the layout determination unit 52 separately allocates the contents to frames provided on a plurality of slides. Then, the layout determination unit 52 generates a query such that each of contents whose main subject is landscape is allocated to a different one of frames (S407).

The respective selection index type determination processing for the event theme “Party” and “Travel” has been described above. Also, with respect to other event theme, an selection index type defining the substance of a template is determined in the similar manner based on attribute information.

In this way, the selection index type, which defines the substance of the template, is dynamically determined based on attribute information. As a result, it is possible to determine various types of selection index types in detail, thereby determining various types of templates in detail, compared with determination in units of event themes.

Although the following shows modification examples of the layout frame determination method employed by the layout determination unit 52, the layout frame determination method is not limited to these modification examples.

(1) A layout frame is determined based on the number of contents included in the content construction, the number of main persons included in each of the contents included in the content construction, or the like, irrespective of whether an event theme has already been determined. More specifically, in the case where the main persons are four family members, a layout frame having four frames is selected. The respective contents in which the four family members appear are each allocated to a different one of the four frames. One of the frames to which a content such as an image where a child appears is to be allocated is increased in size compared with other frames. Also, depending on the substance of photographing, it may be possible to employ layout frame in which the respective size of contents allocated to frames that differ from each other, any of the arranged contents is rotated by a predetermined angle, and so on such that variation is exhibited.

(2) A layout frame appropriate for each event theme is determined. With respect to an event theme “House party” for example, a layout frame is determined such that a content in which a person, especially a main character of a party appears or a content in which many persons make celebration with a cake appear is arranged so as to be large and distinct. Furthermore, a decoration part representing such as cake and decoration is arranged with a certain angle. This makes the viewer to feel that the layout frame is pop.

(3) With respect to an event theme “Picnic in park”, a layout frame having frames of the same ratio is determined such that persons are emphasized, and transition of location and landscape are also are displayed.

Here, the user may designate, via input, a desired one of the above layout frame determination methods. Alternatively, the above layout frame determination methods may be applied in a predetermined order.

Also, although the following shows modification examples of the query determination method employed by the query determination unit 53, the query determination method is not limited to these modification examples. Any query determination method may be employed as long as a query is determined by the query determination unit 53 based on attribute information.

(1) In the case where a target content set includes contents in which persons mainly appear, a query is determined such that a content in which a main person with a high degree of smile or a content in which the main person's face is largely photographed is preferentially selected.

(2) In the case where a target content set includes contents photographed for a short time period, a query is determined that indicates a combination of contents that differ in photograph time as much as possible.

(3) A query appropriate for each event theme is determined. With respect to the event theme “House party” for example, a query is determined such that a content in which a main character of a party appears is selected primarily, a content in which a participant in the party appears is selected secondarily, and a content in which all the participants in the party appear is selected thirdly. At this time, a content in which a cake appears or a content in which sight during dinner appears is also selected.

(4) A query is determined that indicates to select a content for each slide or each scene includes all characters relating to the content in the content construction.

(5) With respect to an event theme “Picnic in park”, a query is determined that indicates (a) to select the same number of contents each in which landscape in a park appears as contents each in which a person appears, (b) to preferentially select a content in which sight during dinner appears among contents photographed at noon, and (c) to preferentially select a content that differs in background or location from other contents in which many movement scenes appear.

Here, the user may designate, via input, a desired one of the above query determination methods, or one of the above query determination methods may be applied in a predetermined order.

Furthermore, layout frame and query may be determined in the following manners.

With respect to contents included in a content set photographed for several days during a travel whose respective substances differ for each day for example, a plurality of selection index type determination tables may be stored beforehand that includes selection index types that are selectable by the user, such that the user freely changes a selection method of overall layout frame and query. Alternatively, layout frame and query may be determined so as to be appropriate for each composition in a content set. For example, with respect to contents included in a content set photographed for one day, layout frame information may be determined for each event unit.

Also, a query may be determined that indicates to select, as a content, not only a photograph but also a video shoot simultaneously with the photograph, a comment attached to the photograph, music as BGM during photographing. Especially, a query may be determined that indicates to select music appropriate for an event theme and the substance of a content set, or to select music appropriate for the user's feeling during viewing the content set as long as the selected music is appropriate for the content set. Furthermore, a template that is more appropriate for usage may be downloaded via the Internet. Alternatively, a new template may be arbitrarily acquired from an external server device or the like and stored.

The view format information storage unit 7 is a storage unit, and stores therein view format information indicating a view format in which a content is playable.

The view format conversion unit 6 converts a content set to a desirable view format, in accordance with the prescription of template based on a design type indicating a design determined by the design type determination unit 4 and a selection index type indicating a selection index determined by the selection index type determination unit 5.

Specifically, the view format conversion unit 6 places a decoration part on a base relating to the design type, places a content prescribed by the query at a position indicated by a layout frame relating to the selection index type to generate a presentation content. Then, the view format conversion unit 6 stores the presentation content and view format information indicating a view format in the view format information storage unit 7. The view format conversion unit 6 selects the type of a presentation content to be generated based on the view format information stored in the view format information storage unit 7. Alternatively, the user may designate the type of a presentation content to be generated.

### 1.2. Operations

The following describes the operations of presentation content generation processing performed by the presentation content generation device with the above structure.

In accordance with the user's instruction, presentation content generation processing is started. Alternatively, at an appropriate time, presentation content generation processing is automatically started.

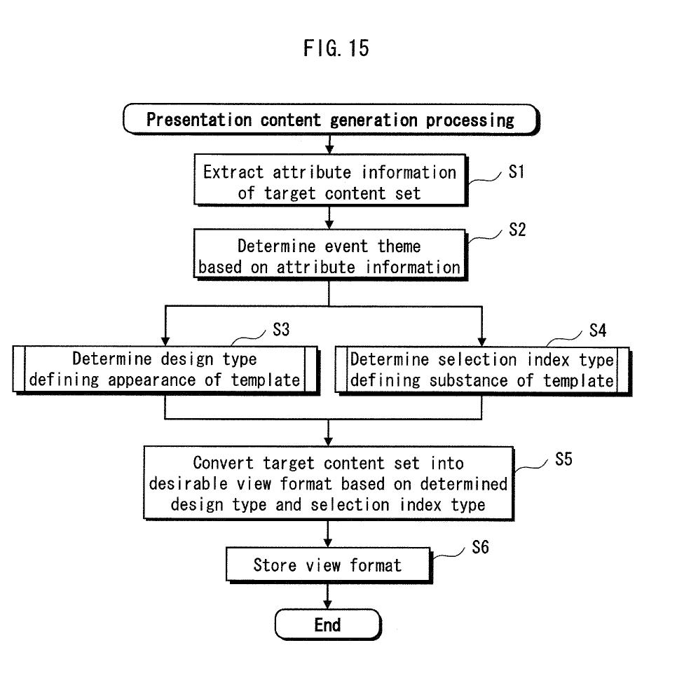

FIG. 15 is a flowchart of presentation content generation processing.

In view mode conversion processing, firstly, the attribute information extraction unit 2 acquires a target content set from the local data storage unit 1. The attribute information extraction unit 2 extracts respective pieces of attribute information of contents included in the acquired target content set (Step S1).

The event theme determination unit 3 determines an event theme of the target content set based on the extracted pieces of attribute information (Step S2).

The design type determination unit 4 determines a design type (Step S3). Here, Step S3 are detailed in the base determination processing shown in FIG. 8 and the decoration part determination processing shown in FIG. 9, which have been described above.

The selection index type determination unit 5 determines a selection index type (Step S4). Here, Step S4 are detailed in the selection index type determination processing shown in FIG. 12, which has been described above.

The view format conversion unit 6 acquires a design type from the design type determination unit 4, and also acquires a selection index type from the selection index type determination unit 5. The view format conversion unit 6 determines a content to be used based on the selection index type, and converts the base indicated by the design type, the decoration part, and the determined content to a desirable view format in accordance with the description of template, thereby to generate a presentation content (Step S5).

After completing the view mode conversion processing, the view format conversion unit 6 stores the presentation content and view format information in the view format information storage unit 7 (Step S6). The storage of the view format information enables the user to view the presentation content in the designated view format by various types of devices.

As described above, unlike a conventional art for uniquely selecting a template in accordance with a general event theme to monotonously select a content for display, the presentation content generation device relating to the present embodiment performs processing of determining a design type and a selection index type of a template based on attribute information relating to local data owned by the user. As a result, it is possible to effectively generate various types of templates for data owned by the user, thereby enabling the user to enjoy viewing the owned data in an effective view format that satisfies the user better.

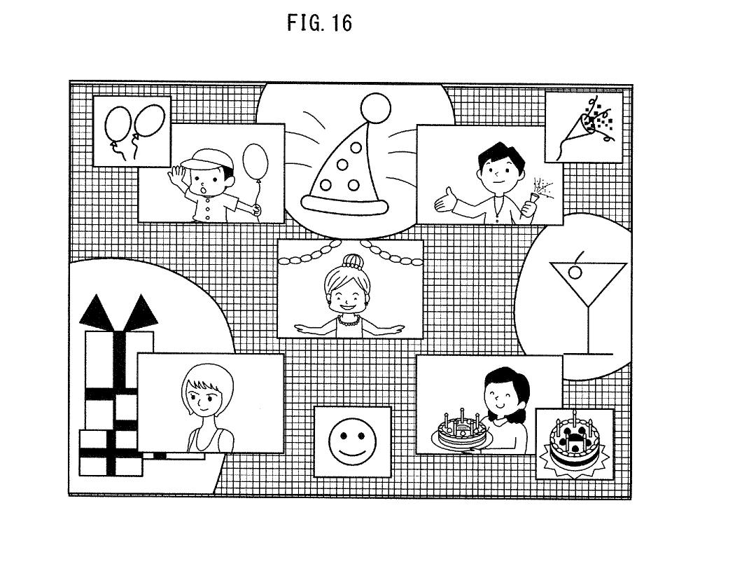

FIG. 16 shows, with respect to event theme “Party”, an example of a presentation content generated by applying a template generated such as described above.

### 2. Embodiment 2

The present embodiment differs from Embodiment 1 mainly in that attribute information additionally has an element of reliability indicating the degree of accuracy of the attribute information.

Attribute information includes a type judged to have a high reliability and a type judged to have a low reliability. Among the types of attribute information, photograph time information is based on EXIF information and is automatically attached by a photographing device, and accordingly has possibilities to be accurate. As a result, the photograph time information can be judged to have a high reliability. Compared with this, among the types of attribute information, analysis metadata information resulting from scene judgment or the like is possibly to be inaccurate due to influence of the analysis precision or the like. As a result, the analysis metadata information can be judged to have a low reliability. Furthermore, among the types of attribute information, usage metadata information is intentionally attached by the user, and accordingly does not necessarily have an accurate attribute. As a result, usage metadata information can be judged to have a low reliability.

In the present embodiment, the presentation content generation device changes the granularity of an event theme to be determined and the granularity of a template to be selected depending on the reliability of attribute information.

### 2.1. Structure

The following describes the present embodiment focusing on the difference from the above embodiment. In the following description, components that are the same as those in Embodiment 1 have the same numerical references, and accordingly explanation thereof are omitted.

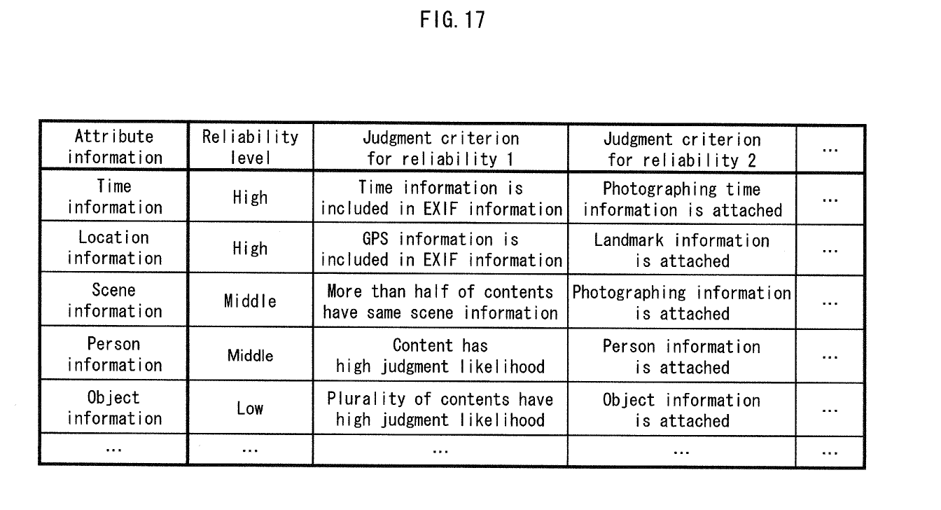

FIG. 17 shows an example of the type of attribute information and criteria for reliability thereof relating to the present embodiment.

In the present embodiment, a result of judgment as to whether attribute information satisfies “Judgment criterion for reliability 1”, “Judgment criterion for reliability 2”, . . . , is shown as a reliability of the attribute information in a section “Reliability level” in FIG. 17.

For example as shown in FIG. 17, among the types of attribute information, in the case where photograph time information is based on EXIF information relating to a content thereof (Judgment criterion for reliability 1) and a photograph time is included in the EXIF information (Judgment criterion for reliability 2), the photograph time information satisfies Judgment criteria for reliability 1 and 2. As a result, the photograph time information is judged to have a high reliability such as shown in the section “Reliability level”. This judgment is made based on that the satisfaction of the criteria for reliability leads to estimation that the photograph time information is device metadata information automatically attached by a photographing device. Note that, however, in the case where photograph time information resulting from an image analysis on the content is attached, the photograph time information is judged to have a “low” reliability or to have “no” reliability.

Also, for example as shown in FIG. 17, among the types of attribute information, in the case where more than half or more of contents included in a content set have the same scene (Judgment criterion for reliability 1) and photographed scene information is attached (Judgment criterion for reliability 2), the scene information is judged to have a “middle” reliability.

Note that the above criteria for reliability and reliability levels, which result from the criteria for reliability, are just one example. Alternatively, other criteria may be used as long as reliability of attribute information is attached based on the attribute information itself and judgment on the level of reliability is made.

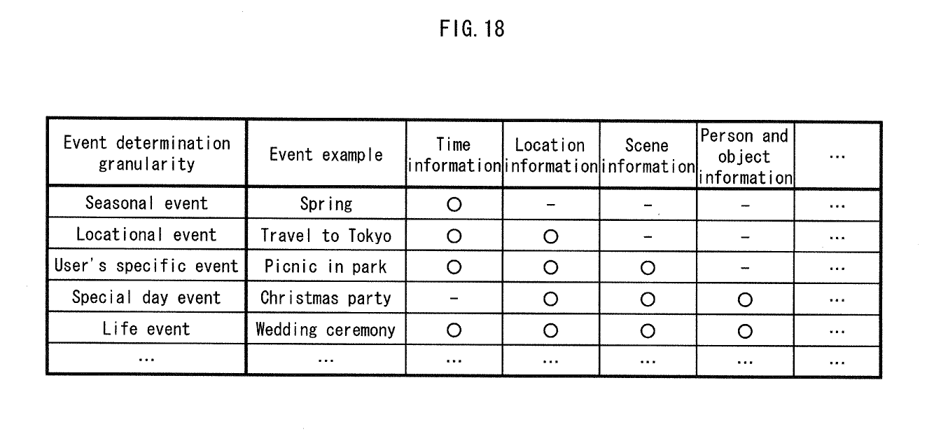

FIG. 18 shows an example of events determined based on the criteria for reliability described above.

In FIG. 18, a circle “∘” means that attribute information has some reliability. In the present embodiment, attribute information having some reliability indicates that the attribute information has any one of “high”, “middle”, and “low” reliabilities resulting from judgment on the criteria reliability. However, the reliability level is not limited to be determination of any one of three levels. Alternatively, the reliability level may be designed so as to compatible with the specifications of the entire system. For example, attribute information having some reliability indicates that the attribute information has either of “high” and “middle” reliabilities resulting from judgment on the criteria reliability.

The event determination granularity indicates the granularity for determination of an event theme. With respect to the first row shown in FIG. 18 for example, the circle “∘” indicating some reliability level is given to only the photograph time information. This specifies only a seasonal event. In the case where the photograph time information indicates “April”, “10 to 12 o'clock in a day in April”, or the like, an event theme is determined in accordance with the granularity of the photograph time information such as an event theme “Spring”, an event theme “Half day in spring”, or the like, respectively.

Similarly, with respect to the second row shown in FIG. 18 for example, the circle “∘” indicating some reliability level is given to the latitude-longitude information in addition to the photograph time information. This specifies a locational event in addition to the seasonal event.

Furthermore, in the case where, latitude-longitude information, and scene information each have some reliability level, an event theme is determined based on a combination of these types of attribute information, such as an event theme “Picnic in park” and an event theme “Swimming in Shonan beach”.

Then, a template appropriate for the determined event theme is selected.

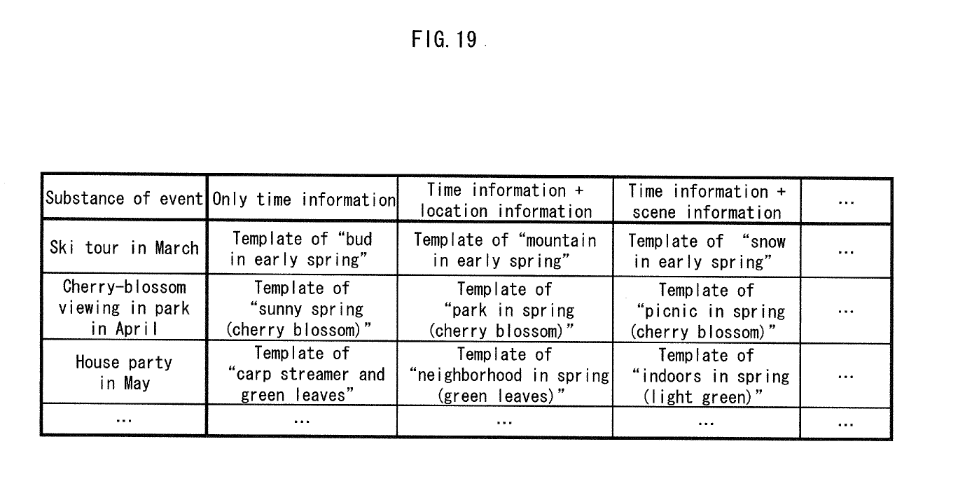

FIG. 19 shows an example where, with respect to one content set, an event theme and a template to be selected differ depending on an acquired type of attribute information.

Assume that, the user inputs to set an event name “Ski tour in March” for the content set, for example.

The event theme determination unit 3 refers to attribute information in order to determine an event theme of the content set. In the case where only photograph time information among the types of attribute information has some reliability and indicates “spring”, the event theme determination unit 3 determines as event theme as “Bud in early spring”. Then, a template corresponding to the event theme “Bud in early spring” is selected.

Also, in the case where photograph time information and latitude-longitude information among the types of attribute information each have some reliability and the photograph time information indicates “spring” and the latitude-longitude information indicates “mountain”, the event theme determination unit 3 determines an event theme as “Mountain in early spring”. Then, a template corresponding to the event theme “Mountain in early spring” is selected.

Furthermore, in the case where photograph time information and scene information among the types of attribute information each have some reliability and the photograph time information indicates “early spring” and the scene information indicates “snow”, the event theme determination unit 3 determines an event theme as “Snow in early spring”. Then, a template corresponding to the event theme “Snow in early spring” is selected.

As described above, it may be possible to employ the structure in which even if the user inputs an event name to be tagged with an event theme and template, the event theme determination unit 3 changes and uses an event theme and a template in accordance with information as analysis metadata information, an event theme and a template that are more appropriate for each content set is selected.

### 2.2. Operations

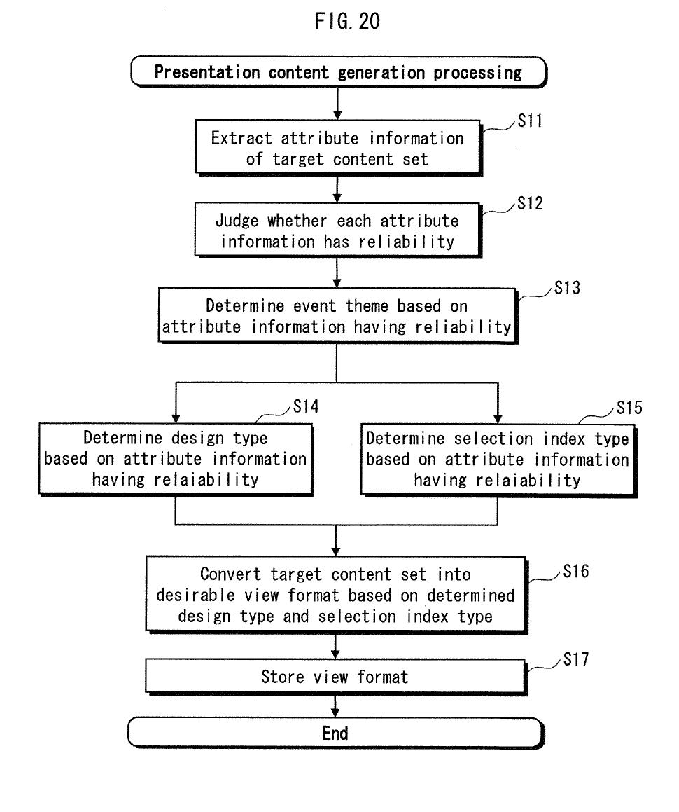

FIG. 20 is a flowchart of presentation content generation processing relating to the present embodiment.

In the presentation content generation processing relating to the present embodiment, the attribute information extraction unit 2 acquires a target content set from the local data storage unit 1, and extracts respective pieces of attribute information of contents included in the acquired target content set (Step S11).

Then, with respect to each of the extracted pieces of attribute information, judgment is made as to whether the piece of attribute information has a reliability (Step S12).

Then, the event theme determination unit 3 determines an event theme of the target content set, based on the substance of the pieces of attribute information and judgment results on the reliability (Step S13).

The design type determination unit 4 determines a design type (Step S14), and the selection index type determination unit 5 determines a selection index type (Step S15). The granularity of each of the selected design type and selection index type to be determined in respective Steps S14 and S15 changes depending on whether each piece of the attribute information has a reliability.

The view format conversion unit 6 acquires the design type and the selection index type from the design type determination unit 4 and the selection index type determination unit 5, respectively, and performs view format conversion processing on the target content set (Steps S16 and S17).

In this way, an event theme and a template are determined based on whether each of extracted pieces of attribute information has a reliability. This enables selection of a design type and a selection index type that are appropriate for each content set, thereby realizing conversion of the content set to a view format that causes the user to have less uncomfortable feeling.

### 3. Embodiment 3

In Embodiment 3, hierarchy processing is performed on a content set based on attribute information by repeatedly classifying contents included in the content set into smaller groups. For example, based on respective pieces of attribute information, contents included in a content set are classified into predetermined group units (sub content sets), and then the contents, which are classified into the groups, are further classified into smaller groups. Also, templates having the hierarchial structure are generated so as to correspond to the hierarchial structure of the content set. A presentation content is generated with use of the generated template, thereby enabling the user to enjoy viewing the contents in a various types of view formats that keep the user from being bored.

### 3.1. Structure

The following describes the present embodiment focusing on the difference from the above embodiments. In the following description, components that are the same as those in the above embodiments have the same numerical references, and accordingly explanation thereof are omitted.

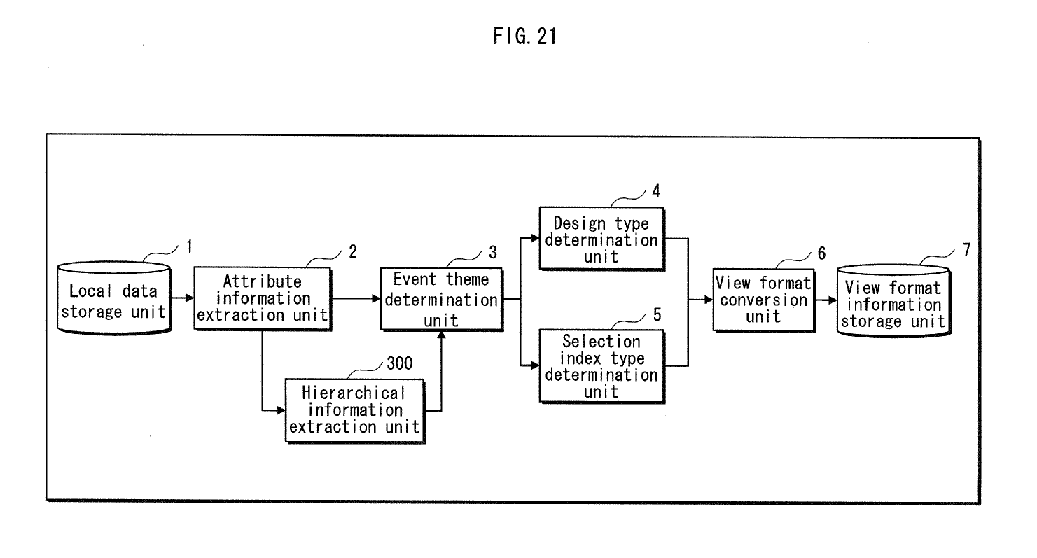

FIG. 21 is a block diagram showing the structure of a presentation content generation device relating to the present embodiment.

The presentation content generation device includes, as shown in FIG. 21, a local data storage unit 1, an attribute information extraction unit 2, an event theme determination unit 3, a design type determination unit 4, a selection index type determination unit 5, a view format conversion unit 6, a view format information storage unit 7, and a hierarchical information extraction unit 300.

The hierarchy information extraction unit 300 performs hierarchy processing on a content set based on attribute information by repeatedly classifying contents included in the content set into smaller groups. Specifically, based on attribute information, the hierarchy information extraction unit 300 classifies the contents included in the content set into groups (sub content sets), and then classifies the groups into smaller groups, and extracts information of the hierarchy of the content set as hierarchical information.

The hierarchy information extraction unit 300 performs this classification in accordance with the standard that defines classification of a content set into certain units (groups).

In the present embodiment, the hierarchy information extraction unit 300 determines an event theme (sub event theme) that is common among contents included in each of the sub content set, in the same manner as the event theme determination unit 3 determines an event theme of each content set.

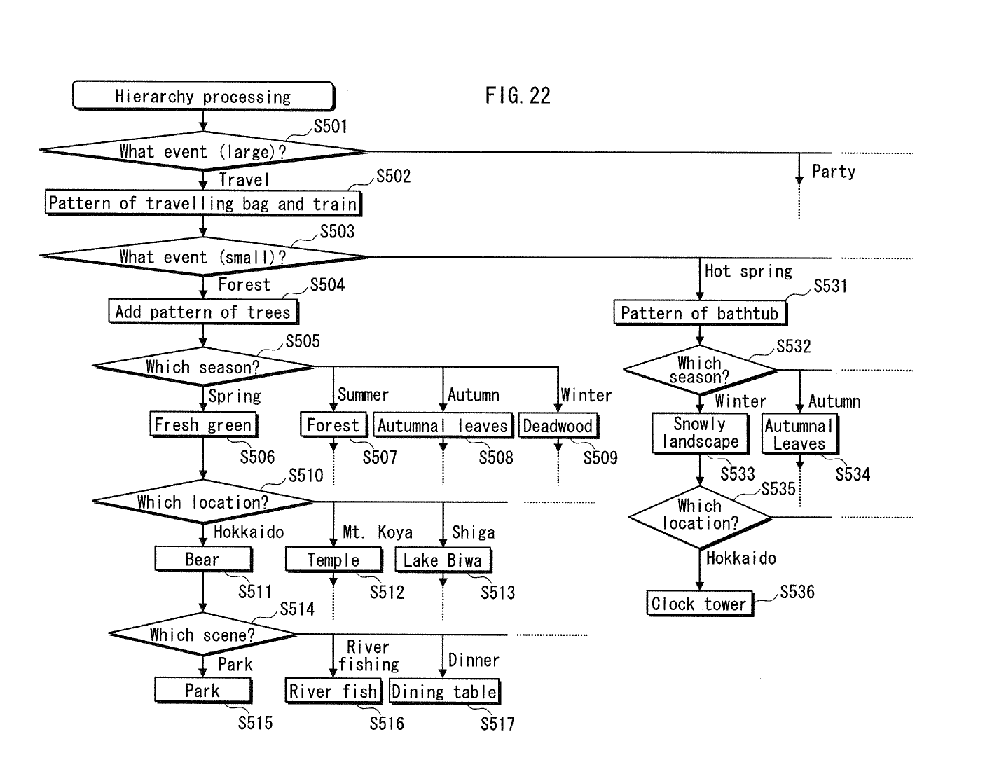

FIG. 22 is a flowchart showing hierarchy processing performed by the hierarchical information extraction unit 300.

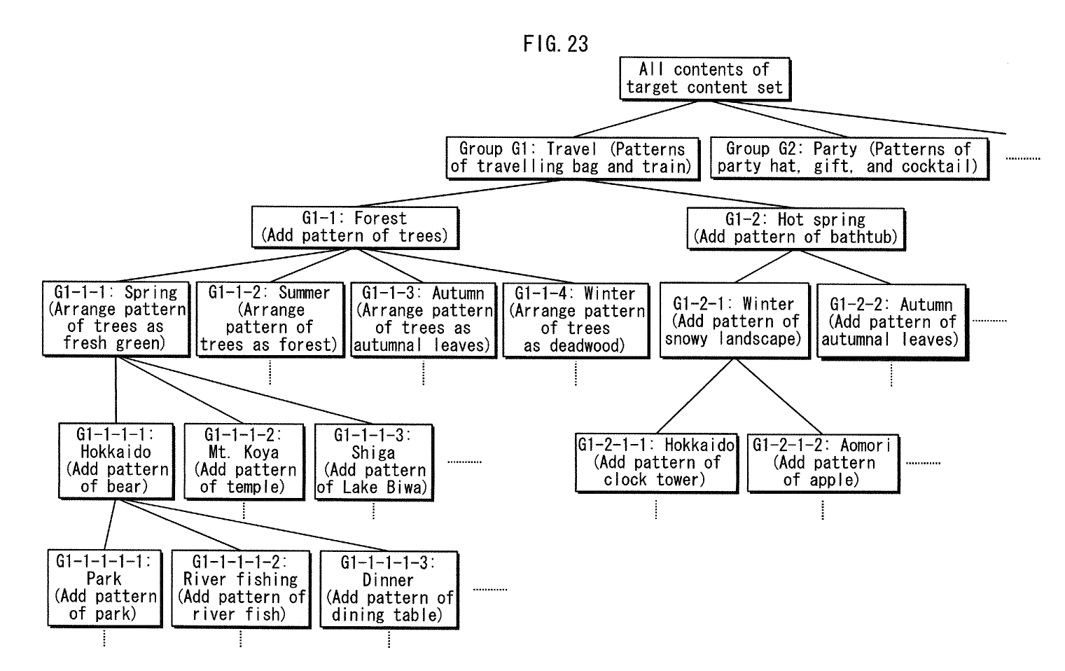

FIG. 23 shows templates (base patterns) one-to-one corresponding to groups in hierarchies.

As shown in FIG. 22, the hierarchical information extraction unit 300 classifies contents included in a target content set into groups in the first-level hierarchy based on attribute information (event (large)) (S501).

In the case where any contents included in the content set are classified into a group “Travel” in the first-level hierarchy (S501: Travel), a base pattern representing travelling bag and train are selected. This corresponds to a base pattern shown in Group G1 (Travel) shown in FIG. 23.

In the case where any contents included in the content set are classified into a group “Party” in the first-level hierarchy (S501: Party), base patterns representing party hat, gift, and cocktail are selected. This corresponds to a base pattern of Group G2 (Party) shown in FIG. 23.

Next, the hierarchical information extraction unit 300 classifies any contents, which are classified into each of the groups in the first-level hierarchy, into one or more groups in the second-level hierarchy based on attribute information (event (small)) (S503). In the case where any contents, which are classified into the group in the first-level hierarchy, are classified into a group “Forest” in the second-level hierarchy (S503: Forest) for example, a pattern representing trees are added to the base pattern representing travelling bag and train (S504). This corresponds to a base pattern of Group G1-1 (Forest) shown in FIG. 23.

In the case where any contents, which are classified into a group in the first-level hierarchy, are classified into a group “Hot spring” in the second-level hierarchy (S503: Hot spring), a pattern representing bathtub is added to the patterns representing travelling bag and train (S531). This corresponds to a base pattern of Group G1-2 (Hot spring) shown in FIG. 23.

Furthermore, the hierarchical information extraction unit 300 classifies any contents, which are classified into each of the groups in the second-level hierarchy, into a group in the third-level hierarchy based on attribute information indicating time and season (Steps S505, S532, . . . ). In the case where any contents, which are classified into a group in the second-level hierarchy, are classified into a group “Spring” in the third-level hierarchy (S505: Spring) for example, the pattern representing trees among the base pattern representing travelling bag, train, and trees, which have been added up to the second-level hierarchy, is arranged so as to be viewed as fresh green (S506). This corresponds to a base pattern of Group G1-1-1 (Spring) shown in FIG. 23. In the case where any contents, which are classified into a group in the second-level hierarchy, are classified into a group “Summer” in the third-level hierarchy (S505: Summer), the pattern representing trees among the base pattern representing travelling bag, train, and trees, which have been added up to the second-level hierarchy, is arranged so as to be viewed as forest (S507). This corresponds to a base pattern of Group G1-1-2 (Summer) shown in FIG. 23. In the case where any contents, which are classified in a group in the second-level hierarchy, are classified into a group “Autumn” in the third-level hierarchy (S505: Autumn), the pattern representing trees among the base pattern representing travelling bag, train, and trees, which have been added up to the second-level hierarchy, is arranged so as to be viewed as autumnal leaves (S508). This corresponds to a base pattern of Group G1-1-3 (Autumn) shown in FIG. 23. In the case where any contents, which are classified into a group in the second-level hierarchy, are classified into a group “Winter” in the third-level hierarchy (S505: Winter), the pattern representing trees among the base pattern representing travelling bag, train, and trees, which have been added up to the second-level hierarchy, is arranged so as to be viewed as deadwood (S509). This corresponds to a base pattern of Group G1-1-4 (Winter) shown in FIG. 23.

Furthermore, the hierarchical information extraction unit 300 classifies any contents, which are classified into each of the groups in the third-level hierarchy, into a group in the fourth-level hierarchy based on attribute information indicating location (Steps S510, S535, . . . ). In the case where any contents, which are classified into a group in the third-level hierarchy, are classified into a group “Hokkaido” in the fourth-level hierarchy for example (S510: Hokkaido), a pattern representing bear is added to the base pattern, which have been added up to the third-level hierarchy (S511). This corresponds to a base pattern of Group G1-1-1-1 (Hokkaido) shown in FIG. 23. In the case where any contents, which are classified into a group in the third-level hierarchy, are classified into a group “Mt. Koya” in the fourth-level hierarchy (S510: Mt. Koya), a pattern representing temple is added to the base pattern, which have been added up to the third-level hierarchy (S512). This corresponds to a base pattern of Group G1-1-1-2 (Mt. Koya) shown in FIG. 23. In the case where any contents, which are classified into a group in the third-level hierarchy, is classified into a group “Shiga” in the fourth-level hierarchy (S510: Shiga), a pattern representing Lake Biwa is added to the base pattern, which have been added up to the third-level hierarchy (S513). This corresponds to a base pattern of Group G1-1-1-3 (Shiga) shown in FIG. 23.

Furthermore, the hierarchical information extraction unit 300 classifies any contents, which are classified into each of the groups in the fourth-level hierarchy, into a group in the fifth-level hierarchy based on attribute information indicating scene (Steps S514, . . . ). In the case where any contents, which are classified into a group in the fourth-level hierarchy, are classified into a group “Park” in the fifth-level hierarchy for example (S514: Park), a pattern representing park is added to the base pattern, which have been added up to the fourth-level hierarchy (S515). This corresponds to a base pattern of Group G1-1-1-1-1 (Park) shown in FIG. 23. In the case where any contents, which are classified into a group in the fourth-level hierarchy, are classified into a group “River fishing” in the fifth-level hierarchy (S514: River fishing), a pattern representing river fish is added to the base pattern, which have been added up to the fourth-level hierarchy (S516). This corresponds to a base pattern of Group G1-1-1-1-2 (River fishing) shown in FIG. 23. In the case where any contents, which are classified into a group in the fourth-level hierarchy, are classified into a group “Dinner” in the fifth-level hierarchy (S514: Dinner), a pattern representing dining table is added to the base pattern, which have been added up to the fourth-level hierarchy (S517). This corresponds to a base pattern of Group G1-1-1-1-3 (Dinner) shown in FIG. 23.

Also with respect to each group in other level hierarchy such as shown in Steps S532 to S536 in FIG. 22, the hierarchical information extraction unit 300 performs processing in the same manner, and accordingly explanation thereof is omitted.

As described above, the hierarchy information extraction unit 300 hierarchically classifies contents included in a content set into groups, and uses a template appropriate for each of the groups. This enables usage of templates that are more appropriate for the substance of the content set.

With respect to each group in each level hierarchy, addition or modification of a pattern is performed on a base pattern which has been determined in the superior hierarchy. Alternatively, a base pattern unique to each group in each level hierarchy may be determined.

Also, classification into groups may be of course performed in accordance with other standard as long as the hierarchy information extraction unit 300 performs classification based on attribute information. For example, classification into groups may be performed in accordance with any of the following standards.

(1) With reference to respective photograph times of contents indicated by device metadata information, contents which have been photographed for a predetermined time period are classified into the same group.

(2) With reference to respective photograph locations of contents indicated by analysis metadata information, contents which have been photographed within a predetermined distance range are classified into the same group.

(3) Contents each having GPS information of device metadata information that indicates a location within a predetermined area such as a park are classified into the same group.

(4) With respect to each of contents, a photograph event unit is determined based on photograph time information and latitude-longitude information of the content, and contents in the same photograph event unit are classified into the same group. This classification method is detailed in “Automatic Organization for Digital Photographs with Geographic Coordinates” by Mor Naaman et al., the 4th ACM/IEEE-CS Joint Conf. on Digital Libraries 2004, pp. 53-62.

(5) With reference to analysis metadata information, with respect to each of contents, a face, person information indicating the number of persons, clothes, or the like is detected, and contents that are approximate to each other in similarity of face or person information by a predetermined value or more are classified into the same group.

(6) Contents having photograph mode information or information such as a parameter of a camera at photographing that are approximate with each other by a predetermined value or more are classified into the same group.

(7) Contents having the same photograph event name given by the user are classified into the same group.

Also, templates of contents that are hierarchized and classified into groups may correlate with one another for a presentation content.

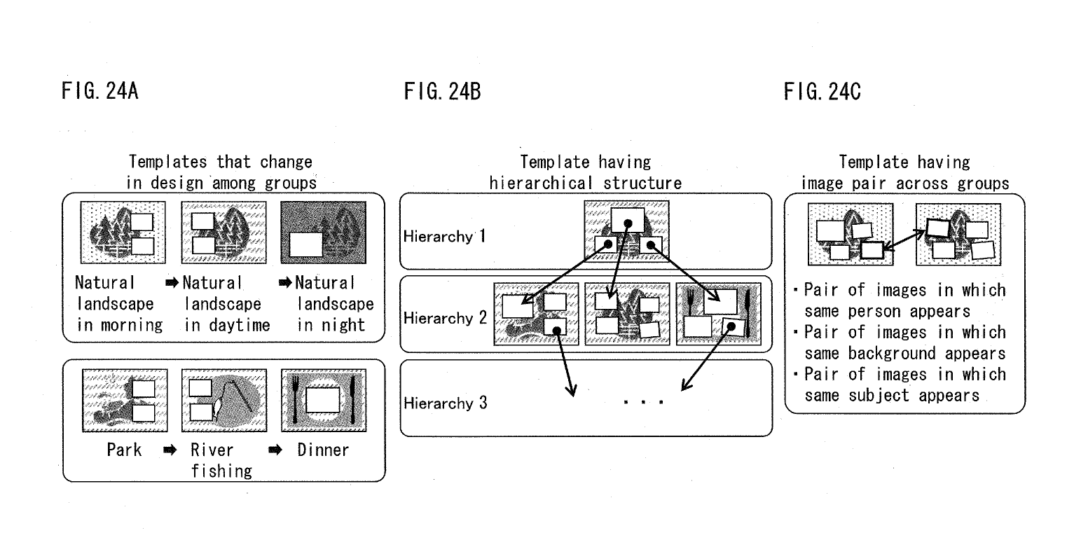

FIG. 24A to FIG. 24 each show an application example of a template corresponding to a content set having the hierarchial structure.

FIG. 24A shows an example of templates that change in design across groups.

FIG. 24A shows examples of template sets each composed of a plurality of templates for a content set in consideration of transition of a story line over groups into which contents included in the content set are classified, with respect to a content set of contents photographed while a user is in a park with natural landscape all the day for picnic. Generation of such a template set enables to represent transition in photograph time at when the user photographed the contents.

According to the template set shown in the upper stage in FIG. 24A, while respective templates of morning, daytime, and night included in the template set has the same background, color (especially a background color of a base) changes among these templates. This enables the user to recognize the transition in photograph time of the contents.

According to the template set shown in the lower stage in FIG. 24A, the templates transit in accordance with the user's behavior. Specifically, the templates change in the following order: a template relating to a park where the user played, a template relating to fishing after the play in the park, and a template relating to dinner after the fishing

FIG. 24B shows an example of templates having a hierarchical structure.

In the case where a content set composed of contents has the hierarchical structure, a template is prepared in group units in each level hierarchy into which the contents are classified. This enables preparation of a template set having the hierarchical structure.

A template in a more superior hierarchy is equivalent to a more general summary of templates in a subordinate hierarchies belonging to the superior hierarchy. This enables the user to switch between templates based on a part in which the user is interested or at when the user hopes to view the presentation content. For example, after viewing contents placed on a template in a superior hierarchy, the user can check the details by viewing contents in a subordinate hierarchy belonging to the superior hierarchy.

As shown in FIG. 24B, contents are allocated on respective frames relating to the terminals of arrows in a slide in Hierarchy 1. In the case where the user designates a content relating to the terminal of one of the arrows for example, display on the screen is switched to a slide on which the content indicated by the arrow in Hierarchy 2 is displayed. On the respective slides in Hierarchy 2, the contents allocated on the respective frames relating to the terminals of the arrows in the slide in Hierarchy 1 are placed in one-to-one correspondence.

FIG. 24C shows an example of templates on which a pair of two contents are placed, respectively. The two contents correlate to each other in some way, and are each classified into a different one of a plurality of groups.

A pair of two contents that are classified into different groups and are common in an item is selected. For example, the selected contents, which are classified into different groups, include the same person, the same background, the same object, or the like. When a template to be displayed switches between the groups, the two contents are displayed on a template before switch and a template after switch, respectively.

As shown in FIG. 24C, within respective frames with thick lines indicated by two arrows, the two contents are allocated, respectively.

This enables the user to switch a template between the groups while the user visibly checks an item common between the groups. As a result, the user can smoothly continue to view slides of a presentation content while the user understands the substance of the presentation content.

Note that any type of template set is used as long as the template set represents transition of a story line among groups into which contents of each content set are classified with use of the hierarchial structure.

### 3.2. Operations

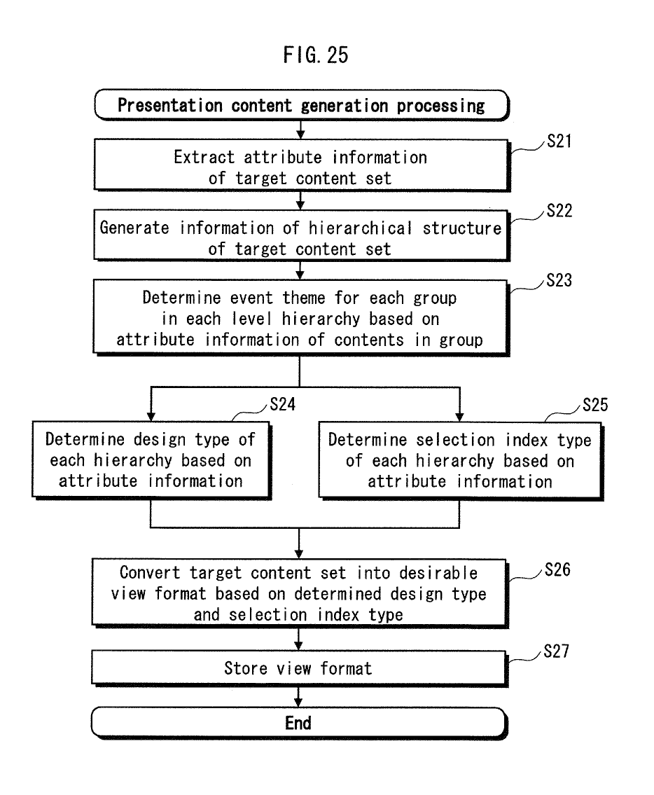

FIG. 25 is a flowchart showing presentation content generation processing relating to the present embodiment.

Firstly, the attribute information extraction unit 2 acquires a target content set from the local data storage unit 1. The attribute information extraction unit 2 extracts respective attribute information pieces from contents included in the target content set (Step S21).

Then, the hierarchical information extraction unit 300 hierarchizes the contents included in the target content set in predetermined group units based on the extracted pieces of attribute information, and generates hierarchical information of the target content set (Step S22).

Then, the event theme determination unit 3 determines an event theme for each group in each level hierarchy based on respective pieces of attribute information of contents of the group in the level hierarchy (Step S23).

The design type determination unit 4 determines a design type, which defines the visual appearance of a template that determines a view format (Step S24). The selection index type determination unit 5 determines a selection index type, which defines the substance of the template (Step S25).

The view format conversion unit 6 acquires the design type and the selection index type from the design type determination unit 4 and the selection index type determination unit 5, respectively, and performs view format conversion processing on the target content set (Steps S26 and S27).

In this way, contents included in a target content set is classified in predetermined group units, and hierarchical information of the target content set is generated. Then, processing of determining a design type and a selection index type of each of templates with a story line is performed based on respective pieces of attribute information of contents in group units in each level hierarchy. This enables the user to select various types of templates with a more detailed story line for data owned by the user. As a result, the user can enjoy viewing the data in an effective view format that satisfies the user better.

### 4. Embodiment 4

In Embodiment 4, based on a content set and attribute information thereof, a presentation content generation device generates and stores therein a selection index type and a design type indicating a decoration part and a design for use in generation of other presentation content afterward by the presentation content generation device.

Embodiment 4 of the present invention is described below with reference to the drawings.

### 4.1. Structure

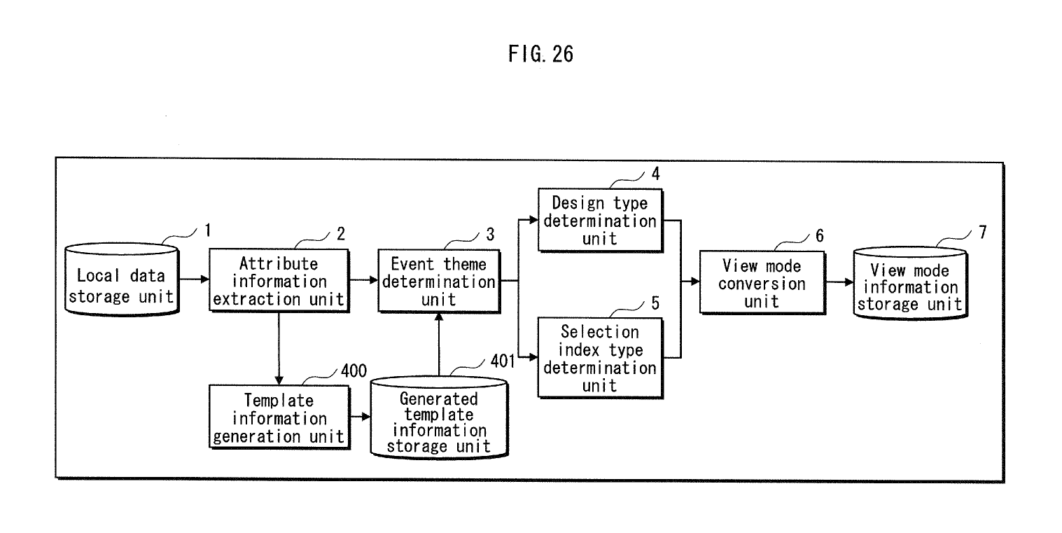

FIG. 26 is a block diagram showing the structure of a presentation content generation device relating to the present embodiment.

The presentation content generation device includes, as shown in FIG. 26, a local data storage unit 1, an attribute information extraction unit 2, an event theme determination unit 3, a design type determination unit 4, a selection index type determination unit 5, a view format conversion unit 6, a view format information storage unit 7, a template information generation unit 400, and a generated template information storage unit 401.

Based on a content set and attribute information thereof stored in the local data storage unit 1, the template information generation unit 400 generates a selection index type and a design type indicating decoration part and a design for use in generation of other presentation content afterward by the presentation content generation device. Then, the template information generation unit 400 stores the generated selection index type and design type in the generated template information storage unit 401, as template information.

A design type may be generated with use of a main character with smile, the same scenes, or a group photograph in which all participants appear, for example.

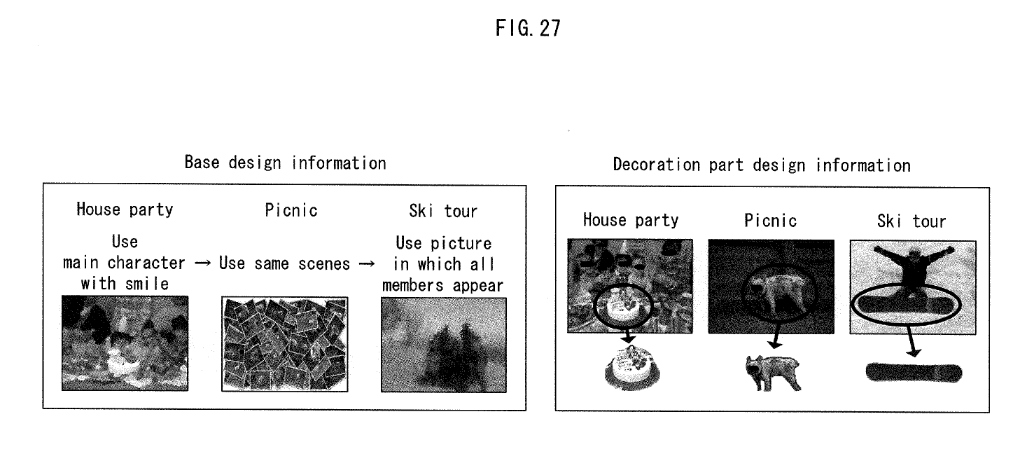

FIG. 27 shows examples a design type to be generated.

Base design information shown in FIG. 27 is generated by the following methods, however, a base design information generation method is not limited to the following methods.

(1) Base design information is generated so as to indicate all or part of colors and patterns of the background in a scene, which is a photograph or a video, where a main person with the best smile appears included in a content set relating to an event such as a house party. Alternatively, base design information is generated so as to indicate a base with use of a scene, which is a photograph or a video, where the main person appears with smile at a degree equal to or higher than a predetermined threshold value. Further alternatively, base design information is generated so as to indicate a base resulting from deforming a glamorous scene that is just like a party.

(2) With respect to a content set relating to an event of picnic, base design information is generated by performing discrete mapping with use of a content judged as a picnic scene included in the content set. Alternatively, base design information may be generated so as to indicate a base design of a content having template information that is the most similar to template information that has been already registered.

(3) With respect to a content set relating to an event of ski tour, a content in which much more persons appear is selected by human detection, and design of the selected content is deformed such that snowflakes are recognizable in the content. Then, base design information is generated so as to indicate the deformed design of the content.

Alternatively, base design information may be generated with use of a background scene with no person, a cooking scene, or many scenes in which an important person appear, for example.

Also, a decoration part is generated by paying attention on a specific subject included in each content, for example.

Decoration part design information shown in FIG. 27 is generated by the following methods, however, a decoration part design generation method is not limited to the following methods.

(1) With respect to an event of a house party, an attention object in the party such as a cake and a candle is extracted by automatic recognition or user's designation, and decoration part design information relating to house party is generated so as to indicate the extracted attention object.

(2) With other event such as a picnic and a ski tour, an attention object is extracted in the same manner, and decoration part design information relating to the event is generated so as to indicate the extracted attention object. Also, a subject important for the user such as a pet animal may be registered as an attention object beforehand such that a decoration part representing the attention object is generated. Alternatively, a content that is the most similar to any decoration part registered beforehand may be registered as a decoration part unique to the user.

Note that these above methods may be combined with one another, or base design information and decoration part design information may be generated in accordance with the substance of each event that is definable.

The following describes a selection index type.

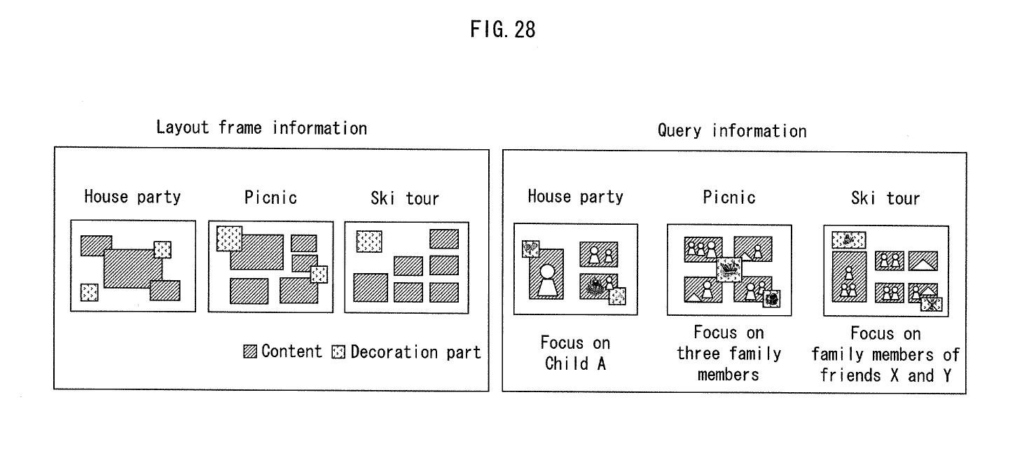

FIG. 28 shows an example of a selection index type relating to the present embodiment.

Layout frame information is generated in the following manner. Layout frame information is generated so as to indicate a layout frame of layout created by the user in accordance with the substance of each event. Alternatively, in the case where a content set relating to an event includes many continuously photographed contents due to a photographing method employed by the user, layout frame information is generated so as to indicate a layout frame in which the continuously photographed contents are displayed. Further alternatively, in the case where composition is employed many times in a content set relating to an event, layout frame information is generated so as to indicate the composition as a layout frame.

Also, query information is generated in the following manner. In the case where a child A is registered each time or photographed many times at a house party, query information is generated so as to select a content in which the child A mainly appears among contents each in which a person mainly appears. Alternatively, in the case where a user often goes picnic with three family members including the user, query information is generated so as to select a content in which the three family members mainly appear among contents each in which a person or landscape mainly appear. Further alternatively, in the case where a user often goes ski tour with respective family members of the user's friends X and Y, query information is generated so as to select a content in which the respective family members of the user's friends X and Y mainly appear among contents each in which a person or snow landscape mainly appears.

Note that these above methods may be combined with one another, or layout frame information and query information may be generated in accordance with the substance of each event that is definable.

The generated template information storage unit 401 is a storage medium, and stores therein template information generated by the template information generation unit 400 such as design type and a selection index type.

A template may be generated by the user's explicit registration as template information. Alternatively, it is possible to employ the structure in which in the case where a predetermined condition defined by the system is satisfied, the template information generation unit 400 starts generation processing and the generated template information storage unit 401 stores therein results from the generation processing.

Templates, which have been generated and stored, are used by the event theme determination unit 3, the design type determination unit 4, and the selection index type determination unit 5, in the same manner as registered template information.

As described above, according to the present embodiment, it is not just that only registered templates are selected based on attribute information of local data owned by the user. By generating a design type and a selection index type based on attribute information of a content set owned by the user, it is possible to use templates resulting from generating the design type and the selection index type, in addition to the registered templates. This enables the user to select various types of templates that are more appropriate for the content set in processing of generating a design type and a selection index type of a template based on attribute information. As a result, the user can enjoy viewing data owned by the user in an effective view format that satisfies the user better.

### 5. Embodiment 5

Embodiment 5 differs from the above embodiments in that one or more templates that are more appropriate for a target content set are selected with use of respective pieces of attribute information of contents included in the content set and feedback from the user.

### 5.1. Structure

The following describes the present embodiment focusing on the difference from the above embodiments. In the following description, components that are the same as those in Embodiment 1 have the same numerical references, and explanation thereof are omitted.

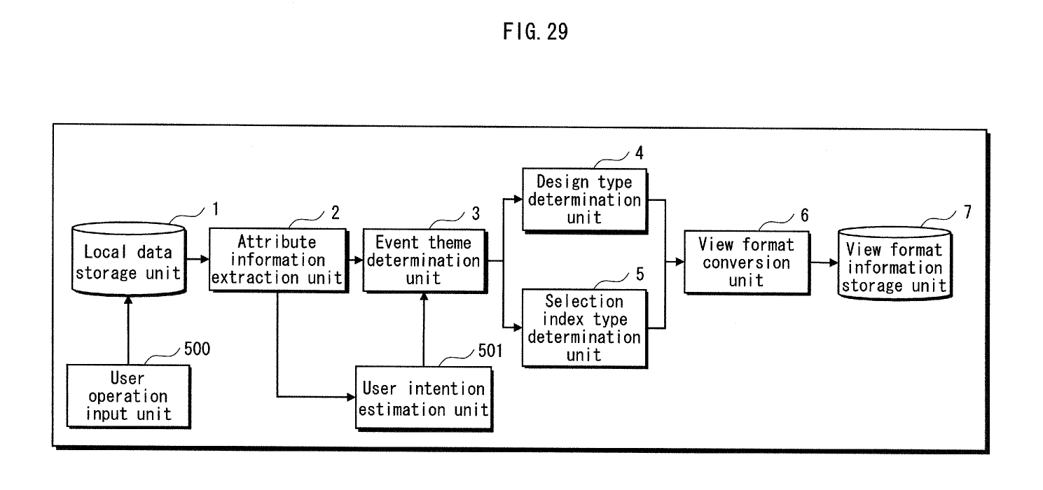

FIG. 29 is a block diagram showing the structure of a presentation content generation device relating to the present embodiment.

The presentation content generation device includes, as shown in FIG. 29, a local data storage unit 1, an attribute information extraction unit 2, an event theme determination unit 3, a design type determination unit 4, a selection index type determination unit 5, a view format conversion unit 6, a view format information storage unit 7, a user operation input unit 500, and a user intention estimation unit 501.

The user operation input unit 500 includes, for example, an input device such as a touch panel display, a mouse, a keyboard, and a remote control. The user operation input unit 500 receives input of user operations for selection processing, registration processing, and the like to be performed on local data stored in the local data storage unit 1. The user operation input unit 500 receives input relating to processing of attaching usage metadata information as attribute information of a content set, processing of selecting and registering a template, feedback processing on a view format after conversion.

In accordance with the input received by the user operation input unit 500, the user intention estimation unit 501 extracts difference information indicating a difference between either a template directly selected by the user or a registered template and a template selected based on the attribute information. Then, based on the extracted difference information, the user intention estimation unit 501 updates a selection standard for template with respect to the attribute information.

Also, in the case where the user operation input unit 500 receives, as a negative feedback to the generated view format, the user's input indicating an instruction to re-select a template because the generated view format differs from the user's desired one, the user intention estimation unit 501 generates a template as a secondary candidate. When performing template generation processing plural times in response to negative feedback (negative element) from the user, the user intention estimation unit 501 specifies and extracts pieces of attribute information mainly used in the template generation processing. Then, the user intention estimation unit 501 generates a template that does not relate to the extracted pieces of attribute information, a template that relates to a piece of attribute information that differs from the extracted pieces of attribute information, or a template that relates to a piece of attribute information that is opposite in properties to the extracted pieces of attribute information. Then, the user intention estimation unit 501 updates the current selection criterion for template such that the generated template is selected.

In the case where, after the user views contents in a view format converted based on selected template information, the user re-selects a template because the converted view format differs from a user's desired one, the user intention estimation unit 501 having the above structure estimates the user's intention who has re-selected the template based on input information received by the user operation input unit 500. This enables more effective selection of a template that matches the user's intention.

### 5.2. Operations

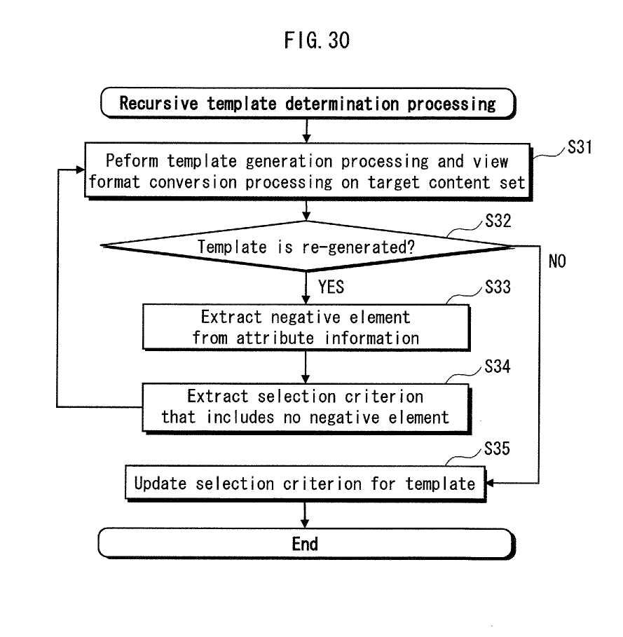

FIG. 30 is a flowchart showing recursive template determination processing relating to the present embodiment.

Firstly, template generation processing is performed based on respective pieces of attribute information of contents included in a content set owned by the user (Step S31). The processing in Step S31 corresponds to the processing in Steps S1 to S6 in Embodiment 1.

Next, judgment is made as to whether the user has performed template re-selection processing (Step S32).

If a result of the judgment in Step S32 indicates that the user has performed template re-selection processing, the user intention estimation unit 501 extracts a negative element that is unaccepted by the user based on a selection criterion for template that has been generated immediately previously (Step S33), and generates a selection criterion for template that includes no negative element (Step S34).

Assume, for example, that an event theme determined in template generation processing is “Travel to forest for Hokkaido in spring”, and attribution information used in the determination includes photograph time information “spring”, latitude-longitude information “Hokkaido”, event (small) “forest”, and event (large) “travel”. In the case where the user does not accept a template of this event theme and re-selects by himself a template with use of mainly event (small) “forest” and event (large) “travel”, the user intention estimation unit 501 updates the selection criterion for template for future selection, by excluding the photograph time information “spring” and the latitude-longitude information “Hokkaido” from the selection criterion for template, and mainly focusing on the event (small) “forest” and the event (large) “travel”.

Then, Step S31 is performed again, and Steps S33 and S34 are repeatedly performed unless the user stops performing template re-selection processing.

If the result of the judgment in Step S32 indicates that the user has not performed template re-selection processing, the user intention estimation unit 501 judges that the selection criterion for template selected immediately previously is accepted by the user. Then, the user intention estimation unit 501 updates the selection criterion for template on the content set having attribute information (Step S35), and ends the recursive template determination processing.

Note that the user intention estimation unit 501 may judge whether the user has performed template re-selection processing, by judging whether the user has performed template re-selection processing within a predetermined time period such as one hour after the user has viewed the contents in the converted view format, for example.

Also, in the case where the user selects and registers a user's favorite template, it may be possible to employ the structure in which high priority is placed on extracted attribute information and a selection criterion for template, such that the user's favorite template is likely to be selected based on the relation between the attribute information and the selection criterion for template.

Alternatively, in the case where the user selects a template which has been firstly selected a predetermined number times or more with respect to an event theme for a special event or the like, it may be possible to update the selection criterion for template such that the user's favorite template is likely to be selected.

Further alternatively, in the case where templates are selectable for each tendency, it may be possible to update the selection criterion for template, by setting to select a template appropriate for a tendency such that a negative element that the user does not hope to select is limited.

As described above, according to the above structure, it is not just that a template appropriate for a content set is selected based on attribute information of local data owned by the user. In the case where the user recursively re-selects a template, the selection criterion for template is updated based on the user's feedback. This enables performance of processing of determining a design type and a selection index type of each of templates in accordance with a selection criterion that matches the user's intention. As a result, the user can effectively generate various types of templates for contents (data) owned by the user, and also can enjoy viewing a content set composed of the contents (the data) in an effective view format that satisfies the user better.

### 6. Modification Example 1

(1) In the above embodiments, the presentation content generation device has all of the functions of generating a presentation content including functions of generating and storing templates. Alternatively, part of the functions of for generating a presentation content, specifically, functions of generating and storing templates or the like may be performed with use of cloud computing.

The cloud computing is a form of computing in which a service provided by a server on a network is available irrespective of other servers on the network.

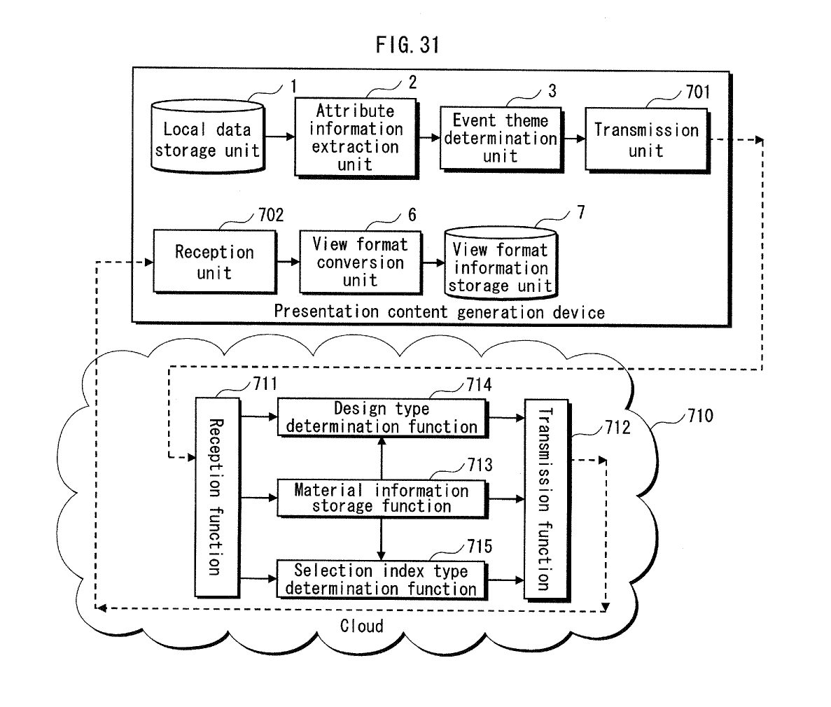

FIG. 31 shows the structure of a system in the case where a cloud has a function of generating templates.

As shown in FIG. 31, the system relating to the present modification example includes a presentation content generation device and a cloud 710 that provides the function of generating templates.

The presentation content generation device includes a local data storage unit 1, an attribute information extraction unit 2, an event theme determination unit 3, a transmission unit 701, a reception unit 702, a view format conversion unit 6, and a view format information storage unit 7.

The cloud 710 has a design type determination function 714 that performs processing that is performed by the design type determination unit 4 included in the respective presentation content generation devices in the above embodiments. Also, the cloud 710 has a selection index type determination function 715 that performs processing that is performed by the selection index type determination unit 5 included in the respective presentation content generation devices in the above embodiments.

In this case, the event theme determination unit 3 transmits an event theme determined therein to the cloud 710 via the transmission unit 701. A reception function 711 of the cloud 710 transmits the event theme, which has been received, to the design type determination function 714 and the selection index type determination function 715. The design type determination function 714 performs the above processing, which is performed by the design type determination unit 4, to determine a design type, and outputs the determined design type to a transmission function 712 of the cloud 710.

Also, the selection index type determination function 715 performs the above processing, which is performed by the selection index type determination unit 5, to determine a selection index type, and outputs the determined selection index type to the transmission function 712.

The transmission function 712 transmits the design type and the selection index type to the reception unit 702.

The reception unit 702 outputs the design type and the selection index type, which have been received from the transmission function 712, to the view format conversion unit 6.

The view format conversion unit 6 is the same as that relating to Embodiment 1, excepting reception of the design type and the selection index type from the reception unit 702. Also, the view format information storage unit 7 is the same as that relating to Embodiment 1.

According to the above structure, it is possible to place part of loads of the presentation content generation device on the cloud 710, thereby realizing load distribution.

Also, templates, decoration parts, and so on may be stored in a material information storage function 713 of the cloud 710 such that the presentation content generation device can freely acquire and use the stored templates, decoration parts, and so on.

According to this structure, it is possible to place all or part of loads of the storage function of the presentation content generation device on the cloud 710, thereby reducing the storage capacity necessary for the presentation content generation device.

Also, it may be possible to employ the structure in which the cloud 710 having a storage function with a large capacity stores therein a large amount of templates, such that the presentation content generation device uses the stored large amount of templates. This enables the presentation content generation device to deal a large amount of templates.

Furthermore, view format information generated by the view format conversion unit 6 may be stored in a view format information storage unit 7 included in an external device. Note that the local data storage unit 1 and the view format information storage unit 7 may be included in the same external device, or each may be included in a different external device.

(2) In the above embodiments, when each of contents included in a content set is placed on a template, the shape and the size of the content are changed and a color of the content is not changed. Alternatively, the content is placed on the template after a digital filter is applied to the content.

The digital filter is for processing and correcting image data. The digital filter exhibits an effect that is the same as that exhibited by a filter of a film camera, and an effect that the color tone of the image data is converted into a monochrome tone, a sepia tone, or the like.

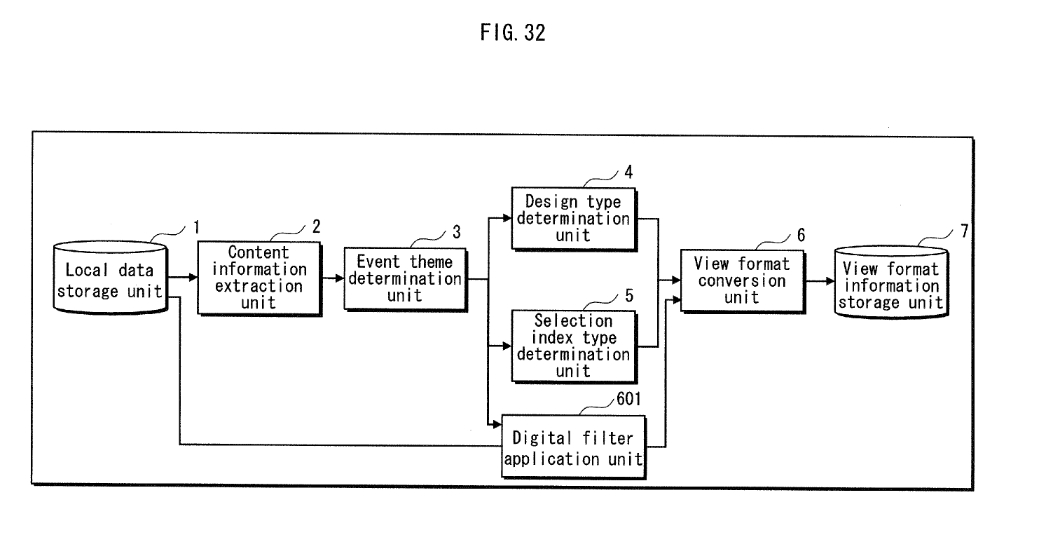

FIG. 32 shows the structure of a presentation content generation device relating to the present modification example.

The presentation content generation device relating to the present modification example differs from that relating to Embodiment 1 in inclusion of a digital filter application unit 601.

The digital filter application unit 601 acquires an event theme from the event theme determination unit 3, and applies, to all or part of contents, an art filter that conforms with the acquired event theme.

The view format conversion unit 6 places the contents on a template after a digital filter that conforms with the event theme has been applied to all or part of the contents.

According to this structure, the contents are each processed so as to conform with the substance of the content set. This enables generation of a presentation content that conforms with the substance of the content set.

The following lists examples of a digital filter and application use thereof. However, the digital filter and the application use thereof are not limited to the lists shown below.

(a) With respect to each event theme or each design type, a type of digital filter to be applied has been determined beforehand, and a digital filter is applied to a content depending on an event theme or a design type of each content.

(b) When a presentation content is generated, a digital filter is applied depending on the substance of each content (image data).

For example, in the case where an image includes a person, an object, and so on, focus adjustment is performed on each of the person, the object, and so on. Furthermore, blur is added to mainly the person's face, and contour enhancement is performed on each of the person, the object, and so on. In the case where an image includes natural landscape, a digital filter is applied to the image so as to be viewed as diorama. In the case where an image includes the sky, the sunset, or the like as the background, a digital filter is applied to the image such that a subject hidden behind the background included in the image is enhanced in black silhouette taking advantage of a color of the background. Also, in the case where an image includes a vigorous sight such as a party, a digital filter is applied to the image such that colors of the image are enhanced to be pop. Furthermore, in the case where an image includes a mellow sight such as a landscape, a digital filter is applied to the image so as to be converted into a monochrome tone as if colors were slightly added such that a subject included in the image is rendered in a tone unique to monochrome images.

Although the examples of the digital filter and the application use thereof have been listed above, the digital filter and the application use thereof are not limited to the those listed above. Alternatively, any digital filter may be applied as long as all types of diversified presentation contents are supported.

(3) The presentation content generation devices described in the respective above embodiments and modification examples may be each embodied as an AV device such as a BD (Blu-ray Disc) recorder, a stationary terminal such as a personal computer and a server terminal, a mobile terminal such as a digital camera and a mobile phone, or the like.

Alternatively, the presentation content generation devices each may be embodied as a server device that provides, as network services, the functions described in the above embodiments and modification examples.

(4) Also, it may be possible to employ the structure in which a program that has described the procedure of the methods described in the above embodiments are stored in a memory, and the program is read by a CPU (Central Processing Unit) or the like from the memory to execute the read program, thereby realizing the above methods.

Alternatively, the program that describes therein the procedure of the above methods may be stored in a storage medium such as a DVD and distributed. Further alternatively, the program that describes therein the procedure of the above methods may be broadly distributed via transmission media such as the Internet.

The respective components relating to the above embodiments each may be typically embodied as an LSI (Large Scale Integration) that is an integrated circuit. Also, each of the components may be separately integrated into a single chip, or integrated into a single chip including part or all of the circuits. Here, the LSI may be called an IC, a system LSI, a super LSI, and an ultra LSI, depending on the integration degree. In addition, the method for assembling integrated circuits is not limited to LSI, and a dedicated circuit or a general-purpose processor may be used. Furthermore, it may be possible to use an FPGA (Field Programmable Gate Array) programmable after manufacturing LSIs or a reconfigurable processor in which connection and setting of a circuit cell inside an LSI is reconfigurable after manufacturing LSIs. Furthermore, if technology for forming integrated circuits that replaces LSIs emerges, owing to advances in semiconductor technology or to another derivative technology, the integration of functional blocks may naturally be accomplished using such technology. The application of biotechnology or the like is possible. Also, calculation of these functional blocks may be performed by a DSP (Digital Signal Processor), the CPU, or the like. Furthermore, processing steps relating to the calculation may be recorded as a program in a recording medium, and the program may be executed.

### 7. Modification Example 2

The following further describes a structure of the presentation content generation device as one embodiment of the present invention, modification examples, and effects thereof.

One aspect of the present invention provides a presentation content generation device, comprising: an extraction unit configured to extract respective attributes of a plurality of contents that constitute a content set, the attributes indicating respective image features of the plurality of contents; a design determination unit configured to determine a design of each of one or more templates based on the attributes, the design indicating a base pattern and a color of the template; a selection placement unit configured to, based on the attributes, select one or more contents to be placed on each of the templates, and determine respective placement positions of the selected contents on each of the templates; and a generation unit configured to place the selected contents on the respective determined placement positions on each of the templates to generate a presentation content.

Also, the extraction unit may classify the plurality of contents into a plurality of groups based on the respective attributes, with respect to at least one of the groups, the design determination unit may determine a design of a template based on respective attributes of one or more contents classified into the group, the selection placement unit may select one or more contents to be placed on the template, and determine respective placement positions of the selected contents on the template, and the generation unit may place the selected contents on the template to generate the presentation content.

With these structures, it is possible to dynamically generate a template different for each group to generate various types of presentation contents to which the generated templates have been applied.

Also, the extraction unit may further classify, into a plurality of groups in a subordinate hierarchy, the plurality of contents which have been classified into the groups, and the generation unit may generate the presentation content such that respective templates relating to the groups in the subordinate hierarchy that belong to the same group in a superior hierarchy are sequentially displayed.

With this structure, it is possible to dynamically generate a template different for each group in a different hierarchy to generate a presentation content, such that respective templates relating to groups in the same hierarchy that deeply correlate to each other and belong to the same group in a superior hierarchy are displayed in a manner in which the user can recognize the change in attribute between the groups.

Also, the presentation content generation device may further comprise: a reception unit configured to receive a user operation for designating any one of one or more contents that are displayed, wherein the generation unit may place, as the presentation content, a first content and a second content having the same attribute on a first template and a second template, respectively, and when the reception unit receives a user operation for designating the second content while the first template is displayed, the generation unit may switch a template to be displayed from the first template to the second template.

With this structure, it is possible to generate a presentation content with a high user-friendliness that enables the user to easily operate to switch between templates in which the user is interested.

Also, the design determination may determine a design with respect to each of the groups, and the generation unit may place two contents having the same attribute on two templates so as to be successively displayed, respectively.

With this structure, it is possible to generate a presentation content that causes the user to have less uncomfortable feeling due to transition between templates.

Also, the extraction unit may judge on a reliability indicating a degree of accuracy of each of the respective attributes of the plurality of contents, the design determination unit may modify the respective determined designs of the templates based on the attributes and the reliabilities, and based on the attributes and the reliabilities, the selection placement unit may select one or more contents to be placed on each of the templates, and change respective placement positions of the selected contents on each of the templates.

With this structure, it is possible to generate a presentation content by transiting between templates tin reflection of respective reliabilities of the attribute information pieces.

Also, the extraction unit may extract, as the image feature of each of the plurality of contents, one of a shape, a pattern, and a color of an object or a background included in the content.

With this structure, it is possible to use, for one or more templates, a design more appropriate for a visual appearance of a content set, a design appropriate for the entire visual appearance of the content set, or a design appropriate for the local visual appearance, thereby reflecting the feature of the visual appearance of the content set in the templates as much as possible.

Also, the presentation content generation device of claim 1 may further comprise: a storage unit configured to store therein beforehand a plurality of templates; and a template reception unit configured, after display of the presentation content, to receive a user instruction to select a template among the templates stored in the storage unit, wherein the design determination unit and the selection placement unit may each refer to, among the attributes used for generating the templates of the presentation content, an attribute that is the same as an attribute relating to the selected template, and may each do not refer to an attribute that is different from the attribute relating to the selected template.

With this structure, it is possible to generate a presentation content by reflecting a user's preference in each template and applying a template having a high degree of the user's satisfaction.

Also, the extraction unit may extract respective attributes of a plurality of contents that constitute another content set, the design determination unit may further store therein part or all of the determined designs, and with respect to the another content set, the design determination unit may determine a design of each of one or more templates based on the attributes with use of part or all of the designs stored therein.

With this structure, it is possible to generate a template in which an image highly relating to the user and an image feature thereof are reflected more. This enables the user to enjoy a content set in an effective view format that satisfies the user better.

Also, with respect to each of the plurality of contents, the generation unit may further store therein a digital filter that conforms the attribute of the content, and the generation unit may apply the conformed digital filter to the content, and place the content to which the digital filter has been applied on the template.

With this structure, the digital filter enables to display of each content in a manner so as to much more conform with an attribute of the content, and to improve the conformity between the content and a template on which the content is placed.

One aspect of the present invention provides a presentation content generation method, comprising: an extraction step of extracting respective attributes of a plurality of contents that constitute a content set, the attributes indicating respective image features of the plurality of contents; a design determination step of determining a design of each of one or more templates based on the attributes, the design indicating a base pattern and a color of the template; a selection placement step of, based on the attributes, selecting one or more contents to be placed on each of the templates, and determining respective placement positions of the selected contents on each of the templates; and a generation step of placing the selected contents on the respective determined placement positions on each of the templates to generate a presentation content.

One aspect of the present invention provides a presentation content generation program that causes a computer to execute: an extraction step of extracting respective attributes of a plurality of contents that constitute a content set, the attributes indicating respective image features of the plurality of contents; a design determination step of determining a design of each of one or more templates based on the attributes, the design indicating a base pattern and a color of the template; a selection placement step of, based on the attributes, selecting one or more contents to be placed on each of the templates, and determining respective placement positions of the selected contents on each of the templates; and a generation step of placing the selected contents on the respective determined placement positions on each of the templates to generate a presentation content.

One aspect of the present invention provides an integrated circuit, comprising: an extraction unit configured to extract respective attributes of a plurality of contents that constitute a content set, the attributes indicating respective image features of the plurality of contents; a design determination unit configured to determine a design of each of one or more templates based on the attributes, the design indicating a base pattern and a color of the template; a selection placement unit configured to, based on the attributes, select one or more contents to be placed on each of the templates, and determine respective placement positions of the selected contents on each of the templates; and a generation unit configured to place the selected contents on the respective determined placement positions on each of the templates to generate a presentation content.

With this structure, it is possible to dynamically generate one or more templates appropriate for an attribute of a content set, thereby generating various types of presentation contents by applying the generated templates. As a result, unlike a conventional art of uniquely determining a template for an event theme, the presentation content generation device with this structure generates a template appropriate for the visual appearance and the substance of a content. This enables the user to enjoy contents owned by the user in various types of view formats.

### INDUSTRIAL APPLICABILITY

The presentation content generation device relating to the present invention is preferably applicable to applications operating on a DVD/BD recorder, a TV, a personal computer, a data server, and the like that each store therein a content set and display the content set in a format such as a digital album and a slide show.

### Reference Signs List

1 local data storage unit
2 attribute information extraction unit
3 event theme determination unit
4 design type determination unit
5 selection index type determination unit
6 view format conversion unit
7 view format information storage unit
41 usage content unit determination unit
42 base determination unit
43 decoration part determination unit
51 usage content construction determination unit
52 layout determination unit
53 query determination unit
300 hierarchical information extraction unit
400 template information generation unit
401 generated template information storage unit
500 user operation input unit
501 user intention estimation unit

1-13. (canceled)

14. A presentation content generation device, comprising:
an extraction unit configured to extract respective first attributes of a plurality of contents that constitute a content set, and extract a second attribute of the content set based on the first attributes, the first attributes indicating respective features of the plurality of contents, the second attribute indicating one common concept among the plurality of contents;
a design determination unit configured to determine a design of each of one or more templates based on the first attributes and the second attribute, the design indicating a base pattern and a color of the template;
a selection placement unit configured to, based on the first attributes and the second attribute, select one or more contents to be placed on each of the templates among the plurality of contents, and determine respective placement positions of the selected contents on each of the templates; and
a generation unit configured to place the selected contents on the respective determined placement positions on each of the templates to generate a presentation content.

15. The presentation content generation device of claim 14, wherein
the extraction unit classifies the plurality of contents into a plurality of groups based on the respective first attributes,
with respect to at least one of the groups, the design determination unit determines a design of a template based on respective first attributes of one or more contents classified into the group and the second attribute,
the selection placement unit selects one or more contents to be placed on the template among the contents classified into the group, and determines respective placement positions of the selected contents on the template, and
the generation unit places the selected contents on the template to generate the presentation content.

16. The presentation content generation device of claim 15, wherein
the extraction unit further classifies, into a plurality of groups in a subordinate hierarchy, the plurality of contents which have been classified into the groups, and
the generation unit generates the presentation content such that respective templates relating to the groups in the subordinate hierarchy that belong to the same group in a superior hierarchy are sequentially displayed.

17. The presentation content generation device of claim 15, further comprising:
a reception unit configured to receive a user operation for designating any one of one or more contents that are displayed, wherein
the generation unit places, as the presentation content, a first content and a second content having the same first attribute among the plurality of contents on a first template and a second template, respectively, and
when the reception unit receives a user operation for designating the second content while the first template is displayed, the generation unit switches a template to be displayed from the first template to the second template.

18. The presentation content generation device of claim 15, wherein
the design determination determines a design with respect to each of the groups, and
the generation unit places two contents having the same first attribute selected among the plurality of contents on two templates so as to be successively displayed, respectively.

19. The presentation content generation device of claim 14, wherein
the extraction unit judges on a reliability indicating a degree of accuracy of each of the respective first attributes of the plurality of contents, and extracts the second attribute based on the respective judged reliabilities of the first attributes,
the design determination unit modifies the respective determined designs of the templates based on the first attributes, the reliabilities, and the second attribute, and
based on the first attributes, the reliabilities, and the second attribute, the selection placement unit selects one or more contents to be placed on each of the templates among the plurality of contents, and changes respective placement positions of the selected contents on each of the templates.

20. The presentation content generation device of claim 14, wherein
the plurality of contents are each an image, and
the extraction unit extracts, as the first attribute of each of the plurality of contents, one of a shape, a pattern, and a color of an object or a background included in the content.

21. The presentation content generation device of claim 14, further comprising:
a storage unit configured to store therein beforehand a plurality of templates; and
a template reception unit configured, after display of the presentation content, to receive a user instruction to select a template among the templates stored in the storage unit, wherein
the design determination unit and the selection placement unit each refer to, among the first attributes used for generating the templates of the presentation content, a first attribute that is the same as a first attribute relating to the selected template, and each do not refer to a first attribute that is different from the first attribute relating to the selected template.

22. The presentation content generation device of claim 14, wherein
the extraction unit extracts respective first attributes of a plurality of contents that constitute another content set, and extracts a second attribute of the another content set based on the first attributes,
the design determination unit further stores therein part or all of the determined designs, and
with respect to the another content set, the design determination unit determines a design of each of one or more templates based on the first attributes and the second attribute with use of part or all of the designs stored therein.

23. The presentation content generation device of claim 14, wherein
with respect to each of the plurality of contents, the generation unit further stores therein a digital filter that conforms at least one of the first attribute of the content and the second attribute, and
the generation unit applies the conformed digital filter to the content, and places the content to which the digital filter has been applied on the template.

24. A presentation content generation method, comprising:
an extraction step of extracting respective first attributes of a plurality of contents that constitute a content set, and extracting a second attribute of the content set based on the first attributes, the first attributes indicating respective features of the plurality of contents, the second attribute indicating one common concept among the plurality of contents;
a design determination step of determining a design of each of one or more templates based on the first attributes and the second attribute, the design indicating a base pattern and a color of the template;
a selection placement step of, based on the first attributes and the second attribute, selecting one or more contents to be placed on each of the templates among the plurality of contents, and determining respective placement positions of the selected contents on each of the templates; and
a generation step of placing the selected contents on the respective determined placement positions on each of the templates to generate a presentation content.

25. A presentation content generation program that causes a computer to execute:
an extraction step of extracting respective first attributes of a plurality of contents that constitute a content set, and extracting a second attribute of the content set based on the first attributes, the first attributes indicating respective features of the plurality of contents, the second attribute indicating one common concept among the plurality of contents;
a design determination step of determining a design of each of one or more templates based on the first attributes and the second attribute, the design indicating a base pattern and a color of the template;
a selection placement step of, based on the first attributes and the second attribute, selecting one or more contents to be placed on each of the templates among the plurality of contents, and determining respective placement positions of the selected contents on each of the templates; and
a generation step of placing the selected contents on the respective determined placement positions on each of the templates to generate a presentation content.

26. An integrated circuit, comprising:
an extraction unit configured to extract respective first attributes of a plurality of contents that constitute a content set, and extract a second attribute of the content set based on the first attributes, the first attributes indicating respective features of the plurality of contents, the second attribute indicating one common concept among the plurality of contents;
a design determination unit configured to determine a design of each of one or more templates based on the first attributes and the second attribute, the design indicating a base pattern and a color of the template;
a selection placement unit configured to, based on the first attributes and the second attribute, select one or more contents to be placed on each of the templates among the plurality of contents, and determine respective placement positions of the selected contents on each of the templates; and
a generation unit configured to place the selected contents on the respective determined placement positions on each of the templates to generate a presentation content.
